(19) United States
(12) Patent Application Publication
(10) Pub. No.: US 2018/0040002 A1
(43) Pub. Date: Feb. 8, 2018

(54) DISTRIBUTING SURVEY QUESTIONS BASED ON GEOLOCATION TRACKING ASSOCIATED WITH A RESPONDENT

(71) Applicant: QUALTRICS, LLC, Provo, UT (US)

(72) Inventors: Blake Andrew Tierney, Orem, UT (US); Milind Kopikare, Draper, UT (US)

(21) Appl. No.: 15/226,649

(22) Filed: Aug. 2, 2016

(51) Int. Cl. G06Q 30/02; H04L 29/08

(52) U.S. Cl. CPC G06Q 30/0201; H04L 67/18

(57) ABSTRACT

The present disclosure is directed towards methods and systems for administering an electronic survey to a respondent via a client device based on geolocation information associated with the client device. For example, the systems and methods include associating a geographic location with an electronic survey. The systems and methods further allow for receiving a geolocation information associated with a respondent's client device. Based on the geolocation information corresponding to the geographic location associated with the electronic survey, the systems and methods determine to provide the respondent's client device with an electronic survey. Accordingly, the systems and methods can provide electronic surveys and electronic survey questions based on a physical location of a respondent.

### BACKGROUND

Developments in communication technologies have resulted in significant advancements in survey technology, and in particular, have led to the advent of electronic survey systems. To illustrate, a user (e.g., a company) can create an electronic survey online, distribute the electronic survey to a number of other users (e.g., customers) via the Internet, and have the other users complete the electronic survey online. When creating and distributing an online electronic survey, a user may employ an online electronic survey system, such as online applications or websites.

Although the advent of electronic survey systems has resulted in significant advancements in electronic survey technology, conventional electronic survey systems suffer from a number of problems. One problem with many conventional electronic survey systems is that a respondent often must independently access and complete the electronic survey online (e.g., on a website). For example, with many conventional electronic survey systems, companies often print invitations to complete electronic surveys on receipts from purchases. For instance, the invitations typically include various codes and/or passwords that a user can enter into a website to access the electronic survey.

The likelihood that a customer keeps the receipt, remembers to take the electronic survey, can correctly access the electronic survey, and then actually takes the electronic survey is relatively low. As such, the conversion rate of such conventional electronic survey invitations is very low. As a result, data and/or information that conventional electronic surveys acquire is typically inaccurate, incomplete, and not reflective of a true customer base. Moreover, to increase the conversion rate of invitations and increase an accuracy of data and/or information acquired through the electronic surveys, companies often must incentivize potential respondents (e.g., by offering prizes, money, free products), which in turn increases the expense associated with administering an electronic survey.

Other conventional electronic survey systems use email to send potential respondents electronic survey invitations to take an electronic survey about an experience (e.g., making a purchase, attending an event, visiting a location, eating at a restaurant, etc.). Typically, conventional electronic survey systems send email invitations to the potential respondents after the experience (e.g., after a purchase). Again, such methods are often ineffective because the invitation reaches the customer too long after the experience, and a respondent may not remember the experience in sufficient detail to provide meaningful responses to the electronic survey. Furthermore, respondents may not be inclined to take an electronic survey while checking their email for purposes unrelated to the experience (e.g., a respondent is at work).

An additional problem with conventional electronic survey systems is that context about when and where a respondent participated in an electronic survey, and a respondent's activities prior to and after participating in the electronic survey, is difficult for conventional electronic systems to obtain. For instance, most conventional electronic survey systems can only obtain such context through specific questions presented in the electronic survey to the respondent. Including questions about such context can result in the electronic surveys being relatively long, and in turn, reduces the likelihood that a respondent will complete the electronic survey. As a result, conventional electronic surveys often sacrifice context in order to increase a likelihood that a respondent will complete an electronic survey.

Conventional electronic survey systems have various additional contextual problems. For example, conventional electronic survey systems are typically unable to collect and provide to an electronic survey administer information about a potential respondent that chose not to respond to the invitation to take an electronic survey (save that the respondent did not respond). Yet another problem with conventional survey systems is there is little ability to verify that a respondent taking an electronic survey was actually involved in the experience about which the electronic survey is seeking data and/or information. Moreover, conventional electronic survey systems rarely can invite a respondent to take an electronic survey while the respondent is having the experience or immediately after the experience about which the electronic survey is seeking data and/or information.

Accordingly, these and other disadvantages exist with respect to conventional systems and methods for distributing electronic surveys.

### SUMMARY

Embodiments of the present disclosure provide benefits and/or solve one or more of the foregoing or other problems in the art with systems and methods for distributing electronic surveys to respondents. For example, the systems and methods disclosed herein allow a survey administrator (e.g., an entity that desires to conduct a survey) to provide electronic surveys to a respondent based on geolocation information associated with the respondent. In some embodiments, the systems and methods receive the geolocation information from a respondent's electronic device (e.g., cellphone, laptop, tablet, etc.). Using the geolocation information associated with the respondent, the systems and methods provide the respondent's electronic device with an electronic survey that is relevant or otherwise related to the geolocation of the respondent. Accordingly, the systems and methods provide a respondent with an invitation and/or access to an electronic survey in a moment that increases the likelihood of the respondent taking the electronic survey, as well as increases the quality of the survey data collected from the respondent.

In one or more embodiments, the systems and methods provide an electronic survey to a respondent based on a detected geolocation of the respondent. Particularly, the systems and methods provide a first electronic survey to a first respondent based on a detected geolocation of the first respondent, and the systems and methods provide a second different electronic survey to a second respondent based on a different detected geolocation of the second respondent. Thus, because the systems and methods provide an electronic survey to a respondent based on the geolocation of the respondent, the systems and methods can provide electronic surveys specific to a detected geolocation to a respondent.

In additional embodiments, the systems and methods can vary survey questions of an electronic survey based on a geolocation of a respondent. For example, a survey administrator of the electronic survey can create (e.g., generate) an electronic survey having survey questions that are optionally provided to the respondent based on the geolocation of the respondent. Therefore, because the systems and methods can vary survey questions of an electronic survey based on a geolocation, the systems and methods can provide a particularized (e.g., customized or individualized) electronic survey to a respondent based on the geolocation of the respondent.

In some implementations of the present disclosure, the systems and methods determine a timing of providing an electronic survey to a respondent based on the geolocation of a respondent. For example, the systems and methods may provide an electronic survey to a respondent based on a respondent entering a geographic area (e.g., passing through a geo-fence surrounding a geographic area), leaving a geographic area, and/or remaining in a geographic area for a specified time period. Thus, because the systems and methods can determine a timing of providing an electronic survey to a respondent based on the geolocation information associated with the respondent, the systems and methods can control a timing of providing the electronic survey that allows the electronic survey to be presented in a customizable moment with respect to a respondent having an experience.

Additionally, in some embodiments, the systems and methods can target and provide electronic surveys to a specific respondent audience (e.g., a group of respondents) based on geolocation of the respondents. For example, a survey administrator may desire to survey respondents that are currently located within a particular geographic area, or that have visited a particular geographic area within a predefined period of time (e.g., a week). Thus, because the systems and methods can target and provide electronic surveys to a specific respondent audience, the systems and methods can create a targeted respondent audience for an electronic survey based on geolocation information associated with the respondents.

Additional features and advantages of the embodiments will be set forth in the description that follows, and in part will be obvious from the description, or may be learned by the practice of such example embodiments. The features and advantages of such embodiments may be realized and obtained by means of the instruments and combinations particularly pointed out in the appended claims. These, and other features, will become more fully apparent from the following description and appended claims, or may be learned by the practice of such example embodiments as set forth hereinafter.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments of the disclosure and are not therefore considered to be limiting of its scope, the disclosure will be described and explained with additional specificity and detail through the use of the accompanying drawings, in which:

FIG. 1 illustrates a schematic diagram of a communication system in accordance with one or more embodiments of the present disclosure;

FIGS. 2A-2B illustrate a sequence-flow method showing the survey system distributing an electronic survey to a client device in accordance with one or more embodiments of the present disclosure;

FIG. 3 illustrates a first example data table of a survey database in accordance with one or more embodiments of the present disclosure;

FIG. 4 illustrates a second example data table of a survey database in accordance with one or more embodiments of the present disclosure;

FIG. 5 shows a schematic representation of a server device having a survey system according to one or more embodiments of the present disclosure;

FIG. 6 shows a flowchart of an example method for distributing an electronic survey based on geolocation information associated with a client device;

FIG. 7 shows a flowchart of another example method for distributing an electronic survey based on geolocation information associated with a client device;

FIG. 8 illustrates a block diagram of an example computing device in accordance with one or more embodiments; and

FIG. 9 is an example network environment of a survey system in accordance with one or more embodiments.

### DETAILED DESCRIPTION

Embodiments of the present disclosure include an electronic survey system for distributing electronic surveys based on geolocation information associated with a client device (e.g., a mobile device) of a respondent. For example, in one or more embodiments, the electronic survey system uses geolocation information associated with the client device (e.g., a respondent's mobile device) to determine whether to provide an electronic survey to the respondent. Additionally, in other embodiments, the electronic survey system uses geolocation information associated with the client device to particularize an electronic survey to be provided to the respondent. Moreover, the electronic survey system determines a timing of providing an electronic survey to a client device of a respondent based on the geolocation information. In one or more additional embodiments, the electronic survey system uses geolocation information to target a specific respondent audience to provide with electronic surveys.

As noted above, the electronic survey system (or simply “survey system”) uses geolocation information associated with a client device to determine whether to provide an electronic survey to the client device. For example, the survey system may provide an electronic survey to a client device of a respondent because the respondent is or has been located within a specific geographic area (e.g., geolocation information associated with a client device of the respondent indicates that the client device is or has been located). In some embodiments, the survey system may determine to provide an electronic survey to a respondent because the respondent crossed a boundary (e.g., a geo-fence) of a geographic area and/or because the respondent has been located within the geographic area for a specified period of time.

By determining whether to provide an electronic survey to a client device based on geolocation information associated with the client device, example embodiments of the survey system provides advantages over conventional electronic survey systems. For example, by providing electronic surveys based on geolocation information, one or more example embodiments of the survey system avoids sending electronic surveys to irrelevant respondents (e.g., respondents that have not experienced an experience about which the electronic survey seeks information). Additionally, because the survey system receives the geolocation information associated with the client device, some embodiments of the survey system may more effectively discard (e.g., detect and filter) false responses in comparison to conventional survey systems. For example, by receiving geolocation information associated with client devices, example embodiments of the survey system can verify that a client device and, as a result, a respondent, actually visited a geographic area about which an electronic survey is seeking data and/or information.

As mentioned briefly above, in addition to determining whether to provide an electronic survey to a respondent, examples of the survey system use the geolocation information to provide a particularized electronic survey to the respondent. For example, an electronic survey may include survey questions that are optionally provided to the respondent based on the geolocation information. Specifically, optional survey questions may be provided in or withheld from an electronic survey by the survey system based on specifics indicated by the geolocation information such as, for example, time periods the respondent is located within a geographic area, a time of day the respondent is located within the geographic area, etc.

By particularizing an electronic survey based on geolocation information associated with a client device, one or more embodiments of the survey system avoids wasting a respondents' time with geolocation specific questions such as, for example, current locations, paths traveled, arrival times, departure times, wait times, etc. Furthermore, the survey system of the present disclosure may provide more specific questions to respondents and as a result, obtain more specific responses, than would otherwise be achievable with conventional electronic survey systems. As a result, the survey system of the present disclosure the electronic surveys may provide shorter electronic surveys relative to conventional electronic survey systems while acquiring a same amount of data through responses. As an additional result, the survey system of the present disclosure may increase a conversion rate of electronic survey invitations relative to conventional electronic survey systems.

In view of the foregoing, a performance of the computer system of the survey system is also improved. Meaning, the efficiently of the survey system is improved because it only provides electronic surveys to users that can answer the survey questions, rather than sending a high number of electronic surveys to large groups where most users in the group cannot accurately provide responses to the electronic survey.

As noted above, in addition to customizing the content of an electronic survey based on geolocation information, some example embodiments of the survey system can determine a timing of providing the electronic survey to the client device based on the geolocation information. In other words, the survey system determines when to send the electronic survey to the client device based on the geolocation information. For example, the survey system may send the electronic survey to the client device as the client device enters and/or leaves a boundary of a geographic area. Furthermore, the survey system may send the electronic survey to the client device while the client device is currently located within geographic area. Moreover, the survey system may send the electronic survey to the client device a certain period of time after the client device enters the geographic area.

By determining a timing to provide (e.g., send) an electronic survey to the client device, the survey system can invite the respondent to take an electronic survey when the respondent is most likely interested in providing feedback about an experience within the geographic area (e.g., the selection of the food at a restaurant). In other words, in one or more example embodiments, the survey system may provide an electronic survey in a moment that increases a likelihood that the respondent will provide a response to the electronic survey. As a result, the survey system of the present disclosure may increase a conversion rate of survey invitations relative to conventional survey systems.

Beyond customizing an electronic survey based on geolocation information, various examples of the survey system can provide electronic surveys to a specific (e.g., targeted) respondent audience. For example, in some instances, a survey administrator may want to survey respondents associated with client devices that are currently located within or have been located within a particular geographic area. The survey system may determine client devices that are currently located within and/or have been located within the particular geographic area and may provide an electronic survey to the client devices based on that determination. Furthermore, in some embodiments, the survey system may determine client devices that have visited the geographic area during a specified period of time and may provide an electronic survey to the client device because the client devices visited the geographic area during the specific period of time.

By enabling a survey system to target a respondent audience based of the geographic location of the respondent audience, the survey system of the present disclosure provides advantages over conventional electronic survey systems. For example, unlike conventional electronic survey systems, the survey system may be able to solicit data about specific locations and/or events based solely on the fact that the respondents' client devices are or were located within a specific geographic area. Furthermore, the survey system of the current disclosure may be able to target an audience most likely to have information related to an electronic survey (e.g., information about a specific location at a specific time).

In some embodiments, the survey system may acquire additional information beyond mere responses to the survey questions. For example, the survey system may track the geolocation information of the client device prior to sending the electronic survey to the client device (e.g., receive different locations of the client device at intervals over a period of time). Moreover, the survey system may track the geolocation information of the client device while a respondent completes the electronic survey. Additionally, the survey system may track the geolocation information of the client device after the respondent completes the electronic survey. As a result, the survey system acquires context of when and where a respondent completes an electronic survey.

Moreover, due to the survey system receiving geolocation information of the client device, the survey system may provide more context in regard to a response (or lack of a response) to the electronic survey when compared to conventional electronic survey systems. For example, the survey system of the present disclosure may provide geolocation context to the survey administrator even if a potential respondent chooses not to respond. These and other features and advantages of example survey systems according to the principles disclosed herein will be discussed in more detail below with respect to the figures.

As used herein, the term “electronic survey” refers to an electronic communication used to collect information. For example, an electronic survey may include an electronic communication in the form of a poll, questionnaire, census, or other type of sampling. In some example embodiments, the terms “electronic survey” may also refer to a method of requesting and collecting information from respondents via an electronic communication such as, for example, a text message, an instant message, an alert within an application, a message within a social media network, and/or an email. As used herein, the term “respondent” refers to a person who participates in, and responds to, an electronic survey.

As used herein, the term “survey question” refers to prompts included in the electronic survey that invoke a response from a respondent. Example types of questions include, but are not limited to, multiple choice, open-ended, ranking, scoring, summation, demographic, dichotomous, differential, cumulative, dropdown, matrix, net promoter score (NPS), singe textbox, heat map, and any other type of prompt that can invoke a response from a respondent. In one or more embodiments, when one or more answer choices are available for a survey question, the term survey question may include a question portion as well as an available answer choice portion that corresponds to the survey question. For example, when describing a multiple choice survey question, the term survey question may include both the question itself as well as the multiple choice answers associated with the multiple-choice question.

As used herein, the term “geolocation information” may refer to any data that refers to a geographic location. The data may include, for example, a coordinate pair that corresponds to (e.g., defines) a geographic location. In some embodiments, the geolocation information may include data that represents two or more geographic locations. Furthermore, the geolocation information may include pathways (e.g., lines) connecting two or more geographic locations.

The term “geographic location” may refer to a real-world position on the earth (e.g., latitude and longitude coordinates). For example, a real-world geographical area may have a defined boundary of geolocation coordinates (e.g., a geo-fence). In other instances, a geographic location is associated with a business, restaurant, attraction, park and/or points or locations of interest (e.g., a POI). Moreover, a geographic location can refer to a defined political boundary, such as a city, a county, a state, etc. Although in some examples, a geographic location can reference to a specific geolocation coordinate, the geographic location can be defined as a geographic area surrounding the specific geolocation coordinate (e.g., a radius of 100 yards around the coordinate).

As used herein, the term “response” refers any type of electronic data representing a response provided to an electronic survey question. Depending on the question type, the response may include, but is not limited to, a selection, a text input, an indication of an answer, an actual answer, and/or an attachment. For example, a response to a multiple-choice question may include a selection of one of the available answer choices associated with the multiple-choice question. As another example, a response may include a numerical value, letter, or symbol that that corresponds to an available answer choice. In some cases, a response may include a numerical value that is the actual answer to a corresponding survey question.

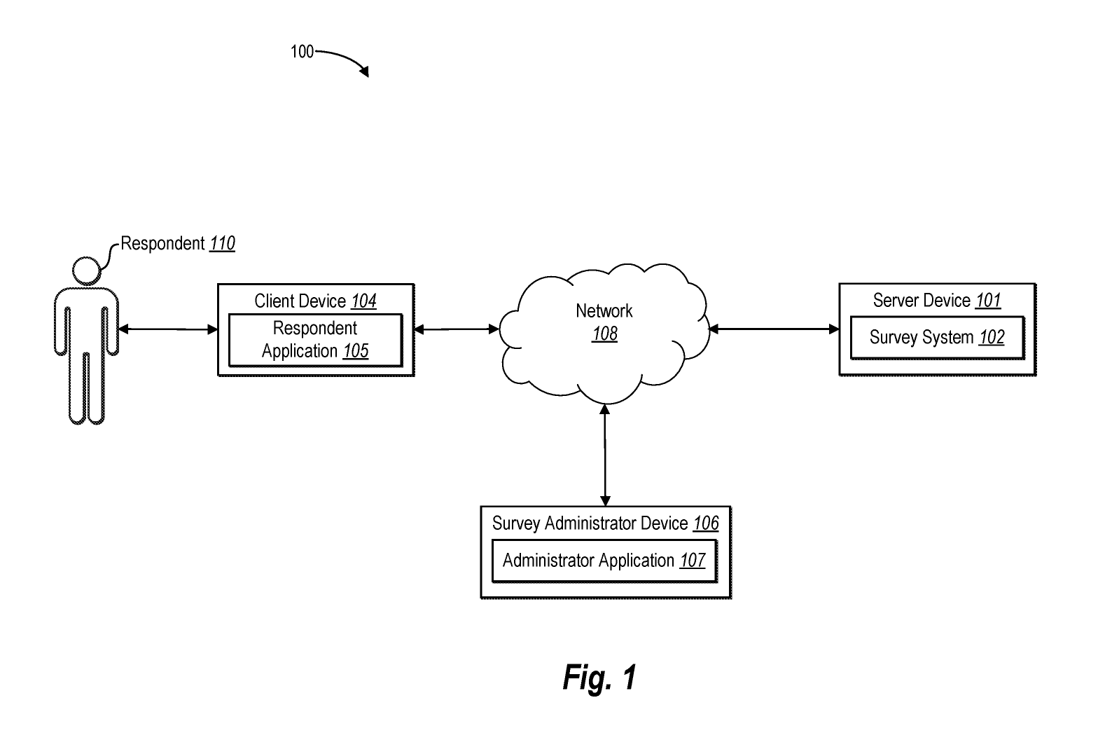

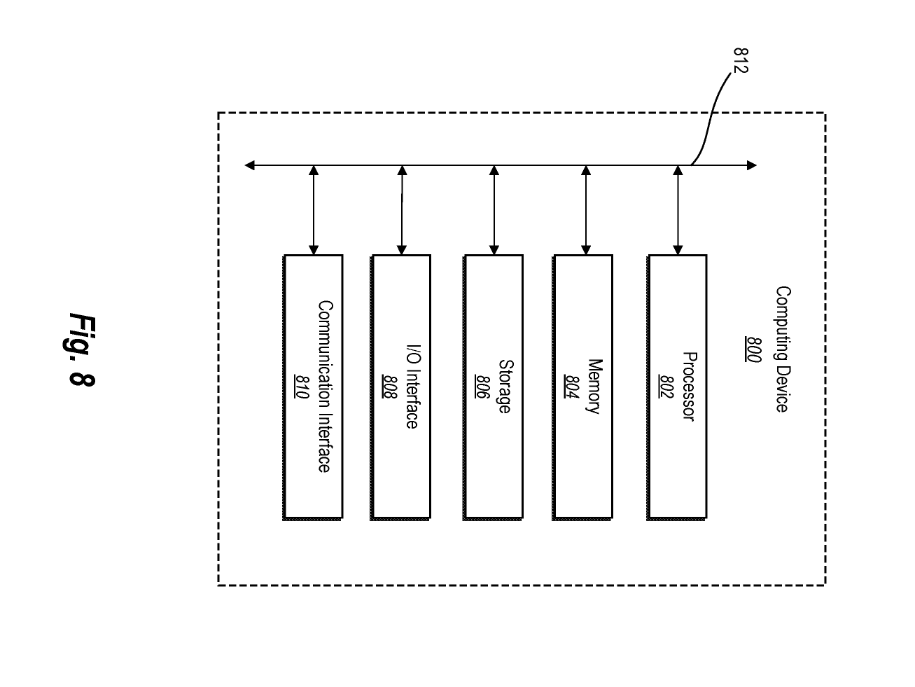

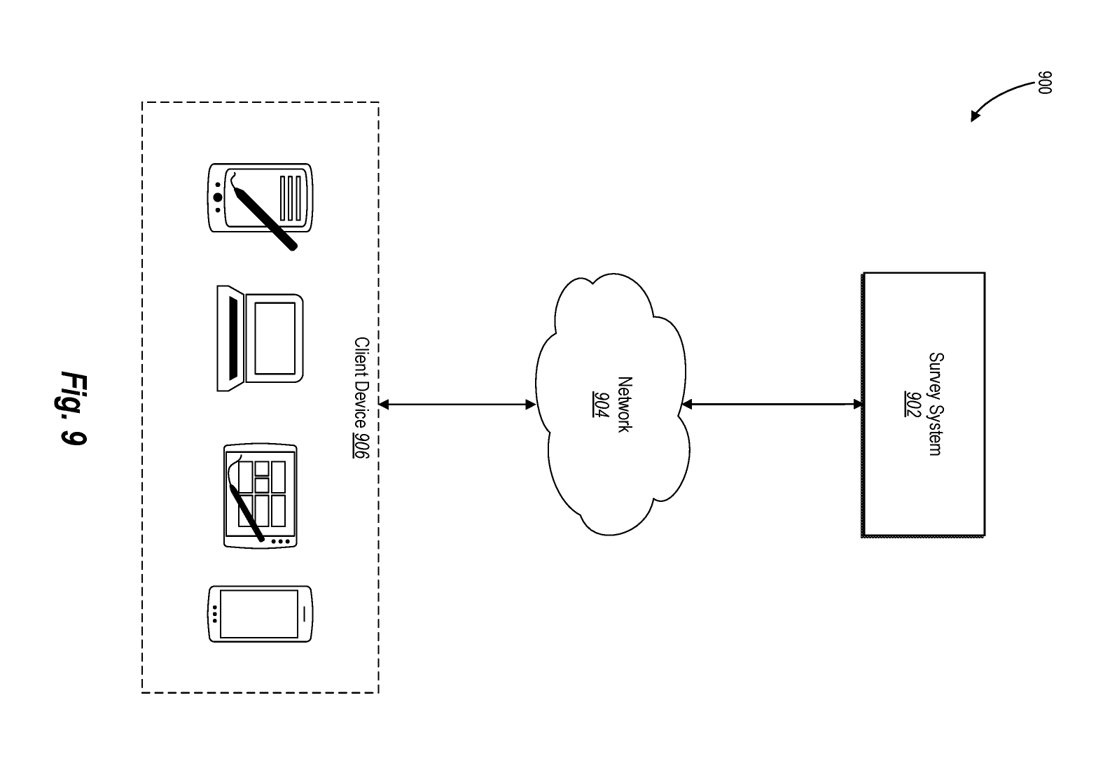

FIG. 1 illustrates a schematic diagram of a communication system 100 in accordance with one or more embodiments of the present disclosure. As illustrated, the communication system 100 includes a client device 104, a survey administrator device 106, a network 108, and a server device 101. The client device 104, the survey administrator device 106 and the server device 101 can communicate via the network 108. The network 108 may include one or more networks, such as the Internet, and may use one or more communications platforms or technologies suitable for transmitting data and/or communication signals. Additional details relating to the network 108 are explained below with reference to FIGS. 8 and 9. Although FIG. 1 illustrates a particular arrangement of the client device 104, the server device 101, the survey administrator device 106, and the network 108, various additional arrangements are possible. For example, the server device 101, and as a result, the survey system 102, may directly communicate with the client device 104, bypassing the network 108.

As illustrated in FIG. 1, a respondent 110 may interface with the client device 104, for example, to access an electronic survey provided by the survey system 102. The respondent 110 may be an individual (i.e., human user), a business, a group, or any other entity. Although FIG. 1 illustrates only one respondent 110, one will understand that the communication system 100 can include a plurality of respondents 110, with each of the plurality of respondents 110 interacting with the communication system 100 using a corresponding client device 104.

In some embodiments, the client device 104 includes a respondent application 105 installed thereon, and the server device 101 may include a survey system 102. The respondent application 105 may be associated with the survey system 102. For example, the respondent application 105 may allow the client device 104 to directly or indirectly interface with the survey system 102. The respondent application 105 may also enable the client device 104 to receive electronic survey from the survey system 102, the respondent to provide a response to the electronic survey, and the client device 104 to provide the response to the survey system 102.

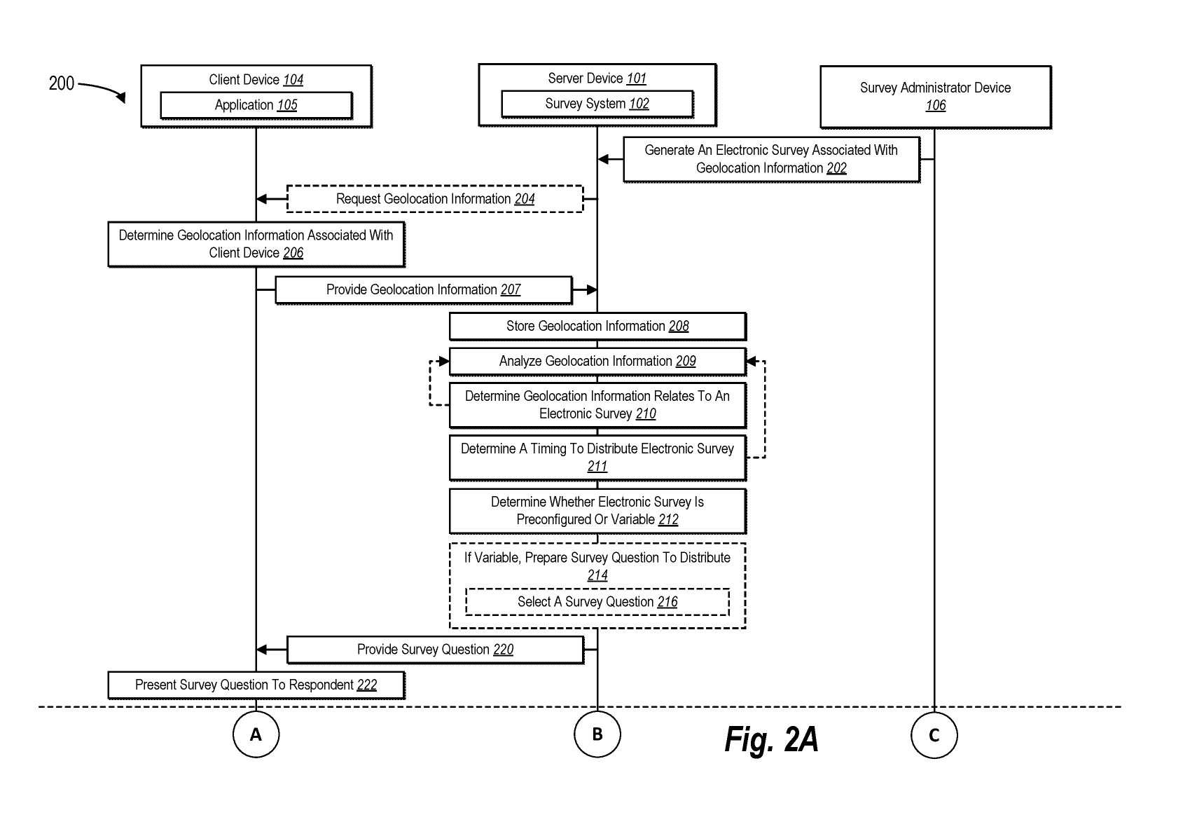

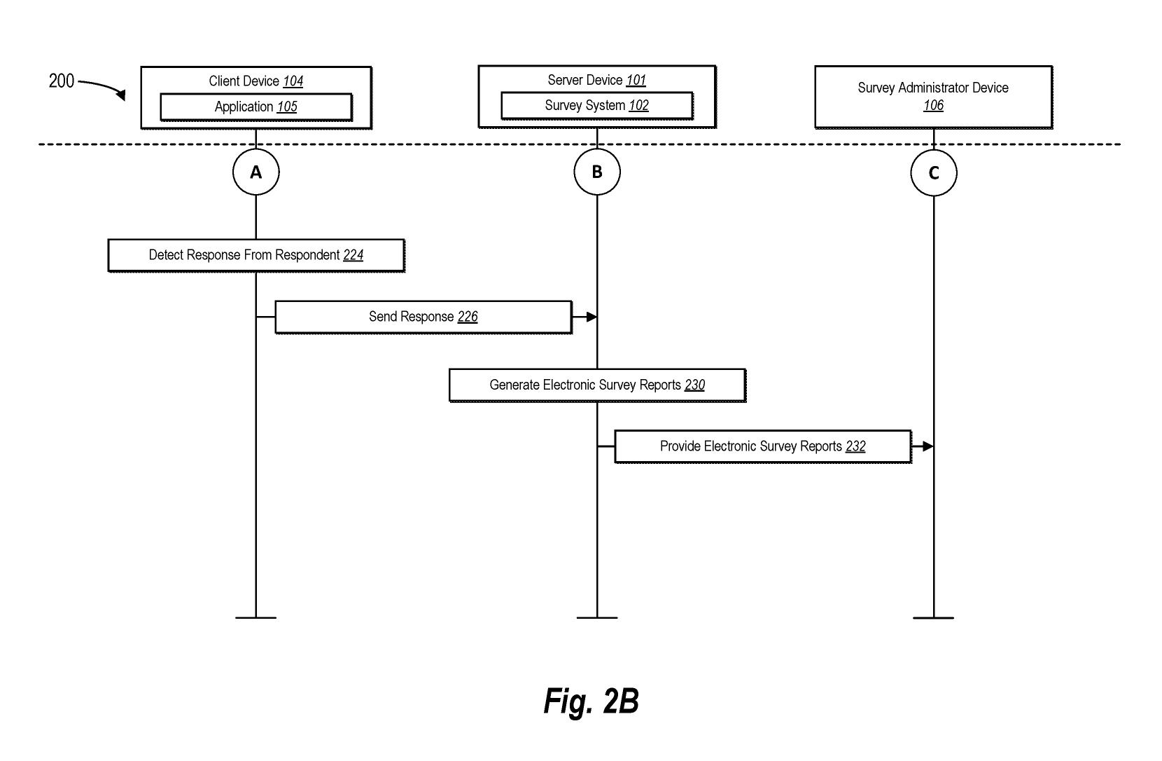

As illustrated in FIG. 1, in some embodiments, the survey administrator device 106 includes an administrator application 107. As used herein, the term “survey administrator” may refer to an entity performing the electronic survey. In other words, “survey administrator” refers to the entity that desires feedback (e.g., data and/or information) and creates, generates, and otherwise causes the survey system to administer an electronic survey. A survey administrator may utilize the administrator application 107 to create an electronic survey using the survey system 102. In some embodiments, the administration application 107 may include a web browser. Creating an electronic survey is described in greater detail below in regard to FIG. 2A.

Both the client device 104 and the survey administrator device 106 may represent various types of computing devices with which respondents and survey administrators may interact. For example, the client device 104 and/or the survey administrator device 106 may be a mobile device (e.g., a cell phone, a smartphone, a PDA, a tablet, a laptop, a watch, a wearable device, etc.). In some embodiments, however, the client device 104 and/or survey administrator device 106 may be a non-mobile device (e.g., a desktop or server; or another type of survey administrator device 106). Additional details with respect to the client device 104 and the survey administrator device 106 are discussed below with respect to FIG. 8.

In some embodiments, the survey system 102 may communicate with the respondent 110 via the client device 104. In particular, the survey system 102 may send an electronic survey (e.g., questions and/or prompts associated with an electronic survey) to the client device 104 via the network 108. In some embodiments, the survey system 102 may determine survey questions to include in the electronic survey based on geolocation information provided to the survey system 102 from the client device 104. More specifically, and as will be discussed in additional detail below, the survey system 102 may receive geolocation information from the client device 104, and in response, the survey system 102 may provide (e.g., send) an electronic survey (e.g., customized survey questions) to the client device 104 based on the geolocation information.

Furthermore, the survey system 102 may provide the electronic survey to the respondent 110 via the network 108 using a variety of distribution channels. For example, the survey system 102 may send an electronic survey via the respondent application 105 of the client device 104. As another non-limiting example, the survey system 102 may send the electronic survey via an online distribution channel (e.g., through a website). In another embodiment, the survey system 102 may send the electronic survey via a messaging distribution channel (e.g., in a chat, text, instant message, email, etc.).

Upon receiving an electronic survey at the client device 104, the respondent 110 may interact with the client device 104 to provide responses to survey questions of the electronic survey. In alternative embodiments, the respondent 110 may use another client device (e.g., a client device at which the respondent 110 did not receive the electronic survey) to respond. In some example embodiments, the respondent 110 may use a combination of client devices 104 to respond to the electronic survey. In other words, the respondent 110 may start to respond to the electronic survey on a first client device 104 and may finish responding on a second client device 104.

In addition to the features described above with reference to communication system 100 in FIG. 1, FIGS. 2A and 2B illustrate a sequence-flow diagram 200 of determining geolocation information of a client device 104 and then providing an electronic survey to the client device 104 based on the geolocation information. The survey system 102 and the client device 104 shown in FIGS. 2A and 2B may each be example embodiments of the survey system 102 and the client device 104 described with regard to FIG. 1.

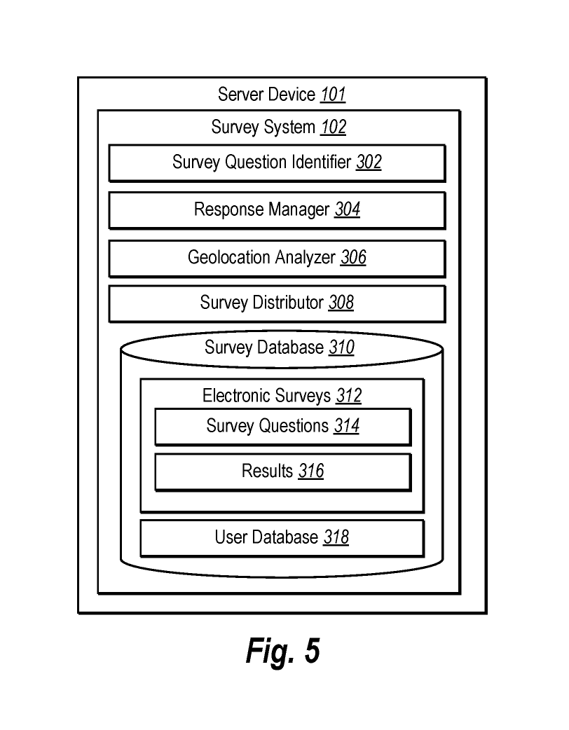

Referring to FIG. 2A, the survey administrator device 106 may generate an electronic survey associated with geolocation information, as shown in step 202. For example, a survey administrator (e.g., a person wanting to administer a survey) can, via the administrator device 106 (e.g., via the administrator application 107), create an electronic survey using the survey system. Specifically, the survey administrator may create survey questions of the electronic survey and potential responses to the survey questions. Furthermore, the survey administrator may create and/or define a format of the survey questions of the electronic survey. For example, the survey administrator may create the survey questions of the electronic survey to be multiple-choice questions, dichotomous questions, and/or open-ended questions. Moreover, the survey administrator may create and/or define the layout of the electronic survey (e.g., the arrangement of survey questions on a page, the number of questions per page, the color scheme of the electronic survey, and/or the methods for navigating within the electronic survey). The survey system, upon detecting a creation of an electronic survey and/or survey question, stores data representing the electronic survey and/or survey question in a survey database. The survey database is discussed in greater detail below in regard to FIG. 5.

Beyond creating the survey questions and potential responses, the survey administrator can, via the administrator device 106, set geolocation settings and/or preferences to associate with the electronic survey. In some embodiments, setting geolocation settings and/or preferences to associate with the electronic survey includes defining a geographic area to associate with the electronic survey. For example, setting geolocation settings and/or preferences to associate with the electronic survey can include specifying a number of times a client device must visit a geographic area, specifying a timing of providing the electronic surveys to client devices, designating an electronic survey as a preconfigured electronic survey (e.g., electronic survey having predetermined set of survey questions) or a variable electronic survey (e.g., electronic survey having interchangeable survey questions), and/or defining triggers (e.g., detected actions of a client device relative to a geographic area) to associate with an electronic survey or survey questions within an electronic survey. Each of these will be discussed in more detail below.

As mentioned above, setting the geolocation settings and/or preferences may include defining a geographic area to associate with the electronic survey. In other words, the survey administrator may tie (e.g., correlate) the electronic survey to a particular geographic area. As will be discussed in greater detail below, when a client device indicates, via geolocation information associated with the client device, that the client device has been or is currently located within a geographic area associated with an electronic survey, the survey system may provide the associated electronic survey to the client device. As a non-limiting example, the survey administrator may define the geographic area to associate with the electronic survey as a building, a park, a city, a state, a country, etc. (e.g., geolocation coordinates defining a particular geographic location or area). As another non-limiting example, the survey administrator may define the geographic area to associate with the electronic survey as a particular type of location.

In some embodiments, the survey administrator may assign a particular point of interest to the electronic survey, and the particular point of interest may correlate to one or more geographic locations (e.g., different locations of the same point of interest). For example, the point of interest may correlate to a particular entity associated with the one or more geographic locations. As a non-limiting example, the point of interest may be a particular type of geographic location (e.g., restaurant chain), and the one or more geographic locations may be individual instances of the particular type of geographic locations (e.g., individual restuarants of the restaurant chain).

In some embodiments, the survey administrator may define the geographic area to associate with the electronic survey via a user interface of the survey administrator device 106. For example, in some implementations of the present disclosure, the survey system 102 presents, via the survey administrator device 106, a map graphical user interface (“GUI”) with which the survey administrator may interact via the survey administrator device 106, and the survey administrator may select a predefined geographic area on the map GUI. The survey system 102, via the survey administrator device 106, may detect interaction with the map GUI, and based on the detected interaction, generate a defined geographical area.

For instance, a survey administrator selects a location on the map GUI or selects and drags over a particular geographic area represented in the map GUI using a user input device (e.g., a mouse, touch screen, etc.). In response to detecting an interaction with the map GUI and defining a geographical area, the survey system 102 assigns an indication of the defined geographic area (e.g., data representing the geographic area) to the electronic survey. In yet additional embodiments, the survey administrator may define the geographic area by defining a geo-fence on the map GUI, and the survey system 102 may assign an indication of geographic area defined by the geo-fence to the electronic survey. In yet further embodiments, the survey administrator may define the geographic area by selecting a predefined area of a map from a plurality of predefined areas of a map via a dropdown box.

Upon detecting a definition of a geographic area to associate with an electronic survey, the survey system 102 may store data indicating the electronic survey and the geographic area associated with the electronic survey in a survey database of the survey system 102. For example, the survey system 102 may assign an identification number (“ID No.”) to the electronic survey and may correlate the ID No. of the electronic survey to the defined geographic area. The survey database of the survey system 102 is discussed in greater detail below in regard to step 210 of FIG. 2A.

In one or more embodiments of the survey system 102, a geographic area may be associated with an entire electronic survey as discussed above and sub-geographic areas (e.g., portions of the defined geographic area) may be associated with particular survey questions of the electronic survey. For example, the survey administrator may associate sub-geographic areas of the defined geographic area with individual survey questions of the entire electronic survey. In other words, sub-geographic areas may be associated with the electronic survey question by question.

As a non-limiting example, the survey administrator may associate a first sub-geographic area with at least one survey question of the electronic survey and a second sub-geographic area with at least one other survey question of the electronic survey. In some embodiments, the survey administrator may associate different survey questions to different sub-geographic areas of the defined geographic area by dragging prepared survey questions to sub-geographic areas of the defined geographic area of the map GUI. The survey system 102, via the survey administrator device 106, may detect survey questions being dragged to different sub-geographic areas represented by the map GUI, and may assign indications of the different sub-geographic areas to respective survey questions. Furthermore, the survey administrator may associate a sub-geographic area with an individual survey question of an electronic survey in any of the additional methods of associating electronic surveys with geographic areas described above.

Upon detecting a selection of a sub-geographic area to associate with a survey question of the electronic survey, the survey system 102 may store data indicating the survey question and sub-geographic area of the defined geographic area associated with the survey question in the survey database of the survey system 102. For example, the survey system 102 may assign a unique question number to the survey question and may correlate the unique question number of the survey question to the sub-geographic area within the survey database.

In addition to defining geographic areas to associate with the electronic survey, setting the geolocation settings and/or preferences may include specifying a threshold number of times a client device 104 must visit a geographic area in order to qualify to receive an associated electronic survey. As used herein, the phrase “visit” a geographic area means that the geolocation information associated with the client device 104 indicates that the client device 104 was and/or is located within the geographic area.

In some embodiments, the survey administrator may set the geolocation settings and/or preferences of an electronic survey such that an electronic survey requires a client device 104 to visit a geographic area associated with the electronic survey at least once before being provided to the client device. In other embodiments, the survey administrator may set the geolocation settings and/or preferences of an electronic survey such that an electronic survey requires a client device 104 to visit a geographic area associated with the electronic survey two or more times before being provided to the client device 104.

In setting the geolocation settings and/or preferences, the survey administrator may select a required number of visits for an electronic survey through a dropdown box and/or selecting icons that represent the required number of visits. In additional embodiments, the survey administrator may input the required number of visits for an electronic survey via an input field of the graphical user interface of the survey administrator device 106. The survey system 102, via the survey administrator device 106, detects a selection and/or input of a required number of visits for an electronic survey and assigns indications of the required number of visits to the electronic survey within the survey database.

Beyond setting a required number of visits for an electronic survey, the survey administrator may specify that the required number of visits must happen within a defined period of time. For example, the survey administrator may specify that the required number of visits must happen within a period of time such as a week, month, year, etc. In some embodiments, the period of time may be a specific period of time (e.g., a specific set of dates). In other embodiments, the period of time is not a specific period of time. Rather, the period of time is merely a specific length of time. In other words, the period of time is defined such that a first visit of the required number of visits is required to be within the period of time of a last visit of the required number of visits (e.g., the first visit must be within a week of the last visit).

In some embodiments, the survey administrator may select a period of time of a required number of visits for an electronic survey through a dropdown box and/or selecting icons that represent the period of time of a required number of visits. In other embodiments, the survey system 102 presents a calendar GUI via the survey administrator device 106 (e.g., via the administrator application 105 of the survey administrator device 106) through which the survey administrator may interact with the survey administrator device 106. Furthermore, the survey administrator may select the period of time on the calendar GUI. In other embodiments, the survey administrator may input the period of time of a required number of visits via an input field of the graphical user interface of the survey administrator device 106. The survey system 102, via the survey administrator device 106, detects a selection and/or input of a period of time of a required number of visits for an electronic survey and assigns indications of the period of time of required number of visits to the electronic survey within the survey database.

As noted above, setting the geolocation settings and/or preferences may also include specifying when the survey system 102 will provide the electronic survey to the client device 104 (e.g., designate “a timing” of providing an electronic survey to the client device 104). In other words, setting the geolocation settings and/or preferences may include associating a timing with each electronic survey. For example, the survey administrator may set the geolocation settings and/or preferences such that the survey system 102 provides the electronic survey to a client device 104 as soon as possible after the client device 104 enters the geographic area associated with the electronic survey. In some embodiments, the survey administrator may set the geolocation settings and/or preferences such that the survey system 102 provides the electronic survey to a client device 104 at least substantially as the client device 104 enters (e.g., within 15 seconds of the client device 104 entering) the geographic area. In one or more embodiments, how soon after the client device 104 enters the geographic area the survey system 102 can provide the survey will be based on network capabilities. As additional non-limiting examples, the survey administrator may set the geolocation settings and/or preferences such that the survey system 102 provides the electronic survey to a client device 104 upon determining that the client device 104 is within the geographic area, after the client device 104 has been located within a geographic area for a specified amount of time, after the client device 104 leaves the geographic area, or after the client device 104 passes through a particular portion of the geographic area.

In some embodiments, the survey administrator may select timings for electronic survey through a dropdown box and/or selecting icons that represent the timings. The survey system 102, via the survey administrator device 106, detects a selection of a timing for an electronic survey and assigns indications of the timing to the electronic survey within the survey database.

In additional embodiments, the survey administrator may designate that the timing to provide an electronic survey to a client device 104 may be determined based on the geolocation information. In other words, the survey administrator may designate that the timing to provide an electronic survey to a client device 104 is variable. For example, the survey administrator may set the geolocation settings and/or preferences such that the survey system 102 provides the electronic survey to a client device 104 when the survey system 102 determines that the client device 104 is within another specific geographic area (e.g., a residential location). Put another way, the survey administrator may set the geolocation settings and/or preferences such that the survey system 102 provides the electronic survey to a client device 104 when a respondent is likely to provide a response.

Additionally, the survey administrator may set limits on how many electronic surveys are provided to a particular client device 104 in a certain period of time. For example, the survey administrator may set a maximum number of electronic surveys to provide to a client device 104 during a period of time (e.g., a day). As a non-limiting example, the survey administrator may set the geolocation settings and/or preferences of an electronic survey such that the electronic survey will only be provided to a particular client device 104 once per day.

Furthermore, as mentioned briefly above, in addition to specifying timings for the electronic surveys, setting the geolocation settings and/or preferences may include designating an electronic survey as preconfigured or variable. A preconfigured electronic survey is a survey with predetermined set of survey questions. In other words, the survey questions of the preconfigured electronic survey do not change. A variable electronic survey has survey questions of the electronic survey are exchangeable based on actions of the client device 104 within the geographic area.

In one or more embodiments, the survey administrator may select whether an electronic survey is preconfigured or variable through a dropdown box and/or selecting icons representing preconfigured or variable. The survey system 102, via the survey administrator device 106, detects a selection of whether an electronic survey is preconfigured or variable and assigns indications of whether an electronic survey is preconfigured or variable within the survey database.

Moreover, as noted above, setting the geolocation settings and/or preferences may include defining actions of the client device 104 (referred to hereinafter as “triggers”) that cause the survey system 102, in response to detecting the triggers, to select at least one survey question to include in an electronic survey (e.g., a variable electronic survey) to provide to the client device 104. For example, the survey administrator may set geolocation settings and/or preferences such that the survey system, in response to determining that a client device 104 has stayed (e.g., lingered) near a sub-geographic area (e.g., a specific area within a geographic area) for a specified period of time, selects a specific survey question to include in a variable electronic survey to be provided to the client device 104.

As another non-limiting example, the survey administrator may set geolocation settings and/or preferences such that the survey system, in response to determining that a client device 104 was or is within a geographic during specific time of day, selects a specific survey question to include in a variable electronic survey to provide to the client device 104. In one or more embodiments, the survey administrator may select triggers (e.g., actions of the client device relative to geographic areas) for potential survey questions of a variable electronic survey through a dropdown box and/or selecting icons that represent the trigger actions. The survey system 102, via the survey administrator device 106, detects a selection of one or more trigger actions for one or more survey questions of an electronic survey and, in response, assigns indications of the trigger to the one or more survey questions of the variable electronic survey within the survey database.

After the survey system 102 generates an electronic survey associated with geolocation information, the survey system 102 requests geolocation information from at least one client device 104, as shown in step 204 of FIG. 2A. For example, the survey system 102 may request geolocation information (e.g., the current location) from one or more client devices 104. In some embodiments, the survey system 102 may send an independent (e.g., stand alone) request for geolocation information to a client device 104. In additional embodiments, the survey system 102 may send a plurality of related requests for geolocation information to one or more client devices 104 over a relatively short period of time. In other words, the survey system 102 may send requests for geolocation information to the one or more client device 104 at intervals over a period of time. As will be discussed below in regard to step 210, sending a plurality of related requests for geolocation information to a client device 104 over a relatively short period of time may allow the survey system to interpolate (e.g., estimate) a path traveled by the client device during that particular period of time.

In additional embodiments, in conjunction with requesting geolocation information, the survey system 102 may request (e.g., solicit) permission from a respondent 110 associated with the client device 104 to determine (e.g., access and/or use) the current location of the client device 104. In other words, the survey system 102 may provide a notification to the client device 104 requesting permission to determine the current location of the client device 104.

As will be described in further detail below in regard to steps 206 and 208 of FIG. 2A, in some embodiments, the survey system 102 may not request geolocation information from the client device 104. Rather, one or more embodiments of the survey system 102 may receive geolocation information that the client device 104 pushes to the survey system 102. For example, in embodiments having a respondent application 105 installed on the client device 104, the application 105 may automatically provide geolocation information of the client device 104 to the survey system 102 without a specific request from the survey system 102.

As illustrated in FIG. 2A, in response to receiving a request for geolocation information associated with the client device 104 (or based upon a push schedule on the client device), the client device 104 determines the geolocation information associated with the client device 104, as shown in step 206. In some embodiments, the client device 104 determines a current location of the client device 104 and/or a change of location of the client device 104. Furthermore, the client device 104 determines a time (e.g., time of day and/or date) at which the client device 104 is located at the current location (e.g., the client device 104 determines a timestamp of the location).

As mentioned briefly above, in one or more embodiments, the client device 104 determines the geolocation information associated with the client device 104 via the respondent application 105 of the client device 104. The respondent application 105 may be associated with the survey system 102. In other words, the respondent application 105 may be a survey system specific application 105. The respondent application 105 of the client device 104 may communicate with (e.g., send data to and receive date from) other components (e.g., hardware and/or software) of the client device 104 in order to ascertain the geolocation information associated with the client device 104.

For example, in some embodiments, the respondent application 105 may communicate with a Global Positioning System (“GPS”) receiver of the client device 104. The GPS receiver communicates with one or more GPS satellites and GPS control stations, as is known in the art, to determine the current position (e.g., location) of the GPS receiver. Thus, the respondent application 105 may acquire data representing the current position of the GPS receiver from the GPS receiver. The data may indicate GPS coordinates (e.g., latitude, longitude, and/or elevation coordinates). Upon receiving the data from the GPS receiver, the respondent application 105 may ascertain the current location (e.g., geolocation information) of the client device 104 from the data.

In additional embodiments, the respondent application 105 of the client device 104 may communicate with third-party applications of the client device 104 to determine the geolocation information associated with the client device 104. The third-party applications may, in turn, communicate with the GPS receiver to acquire data representing the current location of the GPS receiver, and the third-party applications may provide the data to the respondent application 105. As a non-limiting example, the respondent application 105 may communicate with and obtain data from third-party applications such as GOOGLE MAPS®, MAPS (APPLE), or any other application that determines geolocation information from a GPS receiver of the client device 104.

In yet additional embodiments, the client device 104 may not include a survey system specific application (e.g., respondent application 105). In such embodiments, the client device 104 acquires the geolocation information associated with the client device 104 from third-party applications such as the third-party applications described above. Specifically, the client device 104 communicates with (e.g., sends data to and receives data from) the third-party applications, which, in turn, communicate with the GPS receiver to acquire data representing the current location of the GPS receiver, as discussed above. The third-party applications may provide the data (e.g., the geolocation information) to the client device 104. In one or more embodiments, the third-party applications can provide the geolocation information directly to the survey system 102, while in other embodiments servers associated with the third-party applications provide the geolocation information to the survey system 102.

In some embodiments, the client device 104 may not determine the geolocation information via a GPS system (e.g., GPS receiver and satellites). Rather, the client device 104 may determine the geolocation information via a Wi-Fi connection or other connections (e.g., carrier connections) of the client device 104. For example, the client device 104 may determine the geolocation information based on connections of the client device 104 to wireless access points.

As mentioned briefly above, in addition to determining a current location associated with the client device 104, the client device 104 associates a time of day and/or date with the current location. In other words, the client device 104 associates a timestamp with the location within the geolocation information. The client device 104 may acquire the time of day and/or date from the respondent application 105, a time keeping application, and/or any time keeping hardware of the client device 104. Specifically, the client device 104 communicates with one or more of the respondent application 105, time keeping applications, and/or any time keeping hardware and receives data representing a time of day and/or date.

As noted above, in some embodiments, determining geolocation information associated with the client device 104 may further include determining a change of location of the client device 104. The client device 104 may determine a change of location (e.g., a distance between a previous location and a current location) of the client device 104 by comparing previously determined geolocation information (e.g., previous location) of the client device 104 with current determined geolocation information (e.g., current location). Furthermore, the client device 104 associates the change of location with the client device 104 within the geolocation information.

Referring still to FIG. 2A, after or while determining the geolocation information associated with the client device 104 and in response to receiving the request for geolocation information from the survey system 102, the client device 104 provides the determined geolocation information to the survey system 102, as shown in step 207. As discussed above, the geolocation information may include a current location of the client device 104 and/or a change in location of the client device 104.

In alternative embodiments, the client device 104 may not require a specific request for geolocation information from the survey system 102 in order to provide determined geolocation information associated with the client device 104 to the survey system 102. In such embodiments, the respondent application 105 may cause the client device 104 to provide (e.g., push) the geolocation information to the survey system 102 according to predefined rules included in the respondent application 105 of the client device 104. For example, the respondent application 105 may cause the client device 104 to provide the geolocation information to the survey system 102 based on settings of the respondent application 105 and/or detected changes in geolocation information.

In embodiments where the respondent application 105 causes the client device 104 to provide geolocation information to the survey system 102 based on settings of the application 105, the settings of the application 105 may include instructions that, when executed by a processor of the client device 104, cause the client device 104 to provide geolocation information to the survey system 102 on timed intervals (e.g., every 10 seconds). Furthermore, one of ordinary skill in the art would readily recognize that any time interval could be utilized with the client device 104 and survey system 102.

As mentioned briefly above, in addition to causing the client device 104 to provide geolocation information to the survey system 102 based on the settings of the respondent application 105, the respondent application 105 may also cause the client device 104 to provide geolocation information to the survey system 102 in response to determining (e.g., detecting) threshold changes in geolocation information associated with the client device. For example, in some embodiments, the respondent application 105 may determine that the client device's 112 location has changed by a threshold distance (e.g., the client device 104 is located a certain distance from a previous location). In additional embodiments, the application 105 may determine that the client device's 112 location has changed by a threshold elevation. The respondent application 105 may determine (e.g., calculate) changes in location and elevation in any of the manners described above in regard to step 206 of FIG. 2A. Furthermore, upon determining that the client device's 112 location has changed by a threshold amount, the respondent application 105 causes the client device 104 to provide geolocation information to the survey system 102 (e.g., pushes geolocation information to the survey system 102).

Referring again to FIG. 2A, upon receiving and/or acquiring the geolocation information associated with the client device 104, the survey system 102 stores data representing the geolocation information in the survey database, as shown in step 208. For example, the survey database of the survey system 102 includes a list of client devices (e.g., client device ID numbers), and the survey system 102 stores data representing the geolocation information associated with each client device on the list of client devices. Furthermore, the survey system 102 stores data representing locations and/or timestamps indicated in the geolocation information in the survey database. Moreover, the survey system 102 associates the geolocation information and locations and/or timestamps indicated in the geolocation information with the client device 104 within the survey database (e.g., within a table stored in a survey database).

After storing the geolocation information associated with the client device 104 in the survey database, the survey system 102 may optionally analyze the geolocation information, as shown in step 209 of FIG. 2A. For example, in one or more embodiments, the survey system 102 analyzes the geolocation information to determine paths traveled by the client device 104. For example, as discussed briefly above, the geolocation information may include data indicating a plurality of locations visited by the client device 104 over a period of time, and the survey system may, based on the plurality of locations (and timestamps associated with the locations), interpolate a path traveled by the client device 104 during the period of time. In other words, the survey system 102 may connect the plurality of locations in geolocation information to determine a path. Upon determining a path traveled by the client device 104, the survey system 102 stores data representing the path traveled within the survey database and associates the path traveled with the client device 104.

In addition to determining a path, and as briefly mentioned above, the survey system 102 may also analyze the geolocation information to determine whether the geolocation information indicates one or more triggers of electronic surveys. Specifically, the survey system 102 analyzes the geolocation information to determine whether the geolocation information indicates one or more of the selectable triggers described above in regard to step 202 of FIG. 2A. The survey system 102 may determine whether the geolocation information indicates triggers based on the plurality of locations and associated timestamps indicated in the geolocation information. For example, if a portion of the plurality of locations are relatively close to each other in proximity and the timestamps of the portion of plurality of locations indicate a relatively long period of time, the geolocation information may indicate a long wait time. Upon determining triggers indicated in the geolocation information, the survey system stores data representing the triggers within the survey database and associates the triggers with the client device 104.

Based on analyzing the geolocation information associated with the client device 104, the survey system 102 determines that the geolocation information relates to an electronic survey, as shown in step 210 of FIG. 2A. For example, the survey system 102 determines whether the geolocation information associated with the client device 104 (e.g., a location of the client device 104 indicated in the geolocation information) matches a geographic area associated with one or more survey questions of an electronic survey created by the survey administrator. Specifically, the survey system 102 may compare the geolocation information of the client device 104 with geographic area associated with electronic surveys stored in the survey database of the survey system 102. In other words, the survey system 102 may query the survey database of the survey system 102 to compare the defined geographic areas stored therein with the locations indicated in the geolocation information of the client device 104.

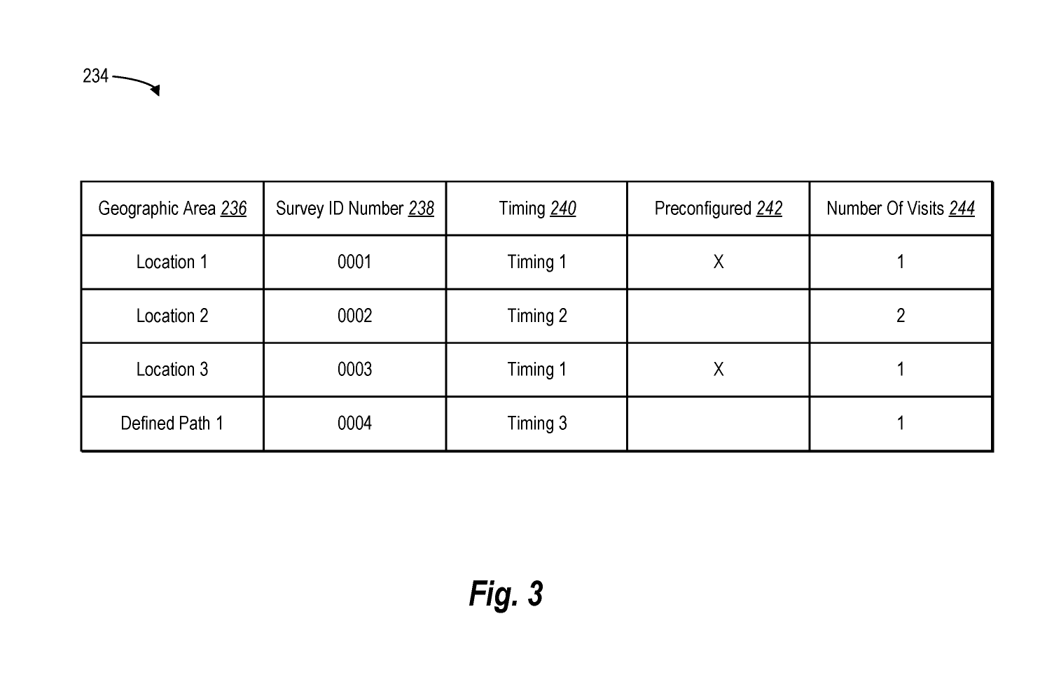

FIG. 3 illustrates an example first data table 234 within the survey database. The electronic survey system can use the first data table 234 to compare the geolocation information of the client device 104 with geographic areas and timings stored in the survey database in order to determine whether to provide an electronic survey to the client device 104. The first data table 234 may include a geographic area column 236. For example, the geographic area column 236 can include a plurality of geographic areas (e.g., Location 1, Location 2, etc.). For instance, the locations listed in the geographic areas column 236 include the geographic locations that the survey administrator defines while creating an electronic survey. The geographic locations in the geographic areas column 236 the survey database may include the various types of defined geographic locations as discussed throughout this disclosure. For instance, the geographic locations can include paths (e.g., a plurality of locations connected together), and defined paths may be defined in ranges (e.g., ranges of coordinates).

In addition, the first data table 234 may include a survey ID number column 238, as illustrated in FIG. 3. Each survey ID number in the survey ID column 238 references a particular electronic survey and is associated 238 is associated with a location in the geographic area 236 column (e.g., associated in the first data table 234 via a row). As illustrated, the first data table can list electronic survey ID numbers (e.g., 0001, 0002, 0003, etc.). In some embodiments, multiple locations can be associated with a single survey ID number. Additionally, or alternatively, multiple survey ID numbers can be associated with a single location. As a result, different geographic areas may be related to a common survey ID number, or various survey ID numbers may be related to a common geographic area. Furthermore, in some embodiments, some of listed geographic areas may at least partially overlap. In other words, a first geographic area may include at least a portion of one or more other geographic areas.

Additionally, and as illustrated in FIG. 3, the first data table 234 may include a timing 240 column having timing instructions related to a particular survey ID number 238. For example, the timing 240 column can include data representing “timings” (e.g., Timing 1, Timing 2, Timing 3, etc.) of when to distribute the electronic surveys indicated by the survey ID numbers. The timings represented by the data may include the timings discussed above in regard to step 202 of FIG. 2A (e.g., based on the preferences and settings set by a survey administrator).

In one or more embodiments, the first data table 234 may include a preconfigured setting 242 representing whether an electronic survey indicated by the survey ID numbers is preconfigured or variable. For example, and as illustrated in FIG. 3, the preconfigured setting 242 can include an indication (e.g., represented by a checkmark) indicating that the electronic survey is preconfigured. In the event of there is no indication, then the corresponding electronic survey is determined to be variable. Based on the determination that an electronic survey is preconfigured or variable, the survey system 102 can determine what or how to send an electronic survey.

Referring still to FIG. 3, the first data table 234 may also include a number of visits column 244 that indicates how many times a client device 104 must visit the location in geographic area 236 column in order for the survey system 102 to provide the electronic survey associated with the survey ID number 238 to the client device 104. For example, in one or more embodiments, the survey system 102 can provide an electronic survey after a single visit (e.g., rows 1, 3, and 4 in data table 234), or alternatively, the survey system 102 can provide an electronic survey after multiple visits (e.g., row 2 in data table 234).

Referring back to FIG. 2A and step 210, as mentioned above, in determining whether the geolocation information associated with the client device 104 relates to an electronic survey, the survey system 102 queries the survey database, which includes the first table 234 as discussed above in regard to FIG. 3. The survey system 102 may compare locations indicated in the geolocation information from the client device 104 with the geographic areas 236 indicated in the first data table 234 of the survey database. The survey system 102 determines that one or more locations indicated in the geolocation information from the client device 104 match one or more geographic areas 236 of the first data table 234 of the survey database if the locations fall within the geographic areas (e.g., within geo-fences defining the geographic areas).

As discussed above, in one or more embodiments, the geographic areas of the first table 234 are defined in ranges such that the locations of the geolocation information do not have to be exactly the same in order to fall within the geographic areas. In other words, the geographic areas of the first table 234 are defined in ranges to give the comparison between the locations of the geolocation information and the geographic areas some flexibility. If the survey system 102 finds a match, the survey system 102 determines that the geolocation information associated with the client device 104 relates to the electronic survey correlating to the matched geographic area.

As mentioned above, in some embodiments, the first data table 234 may include a defined path as the geographic area associated with the electronic survey. Furthermore, as mentioned above, the defined path may include a plurality of locations connected together. In determining whether geolocation information associated with the client device 104 relates to a geographic area corresponding to an electronic survey, the survey system 102 queries the survey database to compare the plurality of locations within the database with the plurality of locations of a path traveled indicated in the geolocation information. In some embodiments, the electronic survey may require that only a majority (e.g., greater than 50%) of the plurality locations of the defined path match the plurality of locations of the path traveled of the geolocation information in order to determine that the geolocation information associated with the client device 104 relates to the electronic survey. In alternative embodiments, the electronic survey may require that 40%, 50%, 60%, 70%, 80%, 90%, or 99% of the plurality locations of the defined path match the plurality of locations of the path traveled of the geolocation information in order to determine that the geolocation information associated with the client device 104 relates to the electronic survey.

In one or more embodiments, determining that geolocation information of a client device 104 relates to an electronic survey includes determining whether geolocation information associated with a plurality of client devices 104 is related to an electronic survey. For example, the survey system 102 may determine whether the geolocation information associated with each client device 104 of the plurality of client devices 104 is related to an electronic survey in any of the manners described above. By determining whether geolocation information associated with a plurality of client devices 104 is related to an electronic survey, the survey system 102 may provide electronic surveys to a specific (e.g., targeted) respondent 110 audience. For example, as noted above in regard to step 202 of FIG. 2A, in one or more embodiments, the settings and/or preferences of an electronic survey may target client devices 104 that are currently located within or have been located within a particular geographic area during a particular period of time. Determining whether a client device 104 has been located within a geographic area during a particular period of time is discussed below. As a result, the survey system 102 may use the geolocation information of a plurality of client devices 104 to target a specific respondent 110 audience to provide with an electronic survey.

In some embodiments, the survey system 102 may determine that two or more electronic surveys relate to the geolocation information associated with the client device 104. In other words, the locations indicated in the geolocation information from the client device 104 may fall within two or more of the geographic areas 236 of the table 234. In such instances, the survey system 102 may determine which of the two or more matched electronic surveys to provide to the client device 104. In some embodiments, the survey system 102 may consider one or more factors in determining which of the two or more matched electronic surveys to provide to a client device 104. The factors may include which of the matched electronic surveys was provided to a client device 104 last, client preferences, financial considerations (e.g., a particular survey administer paid for priority), an amount of locations of the geolocation information matching the geographic areas (e.g., how close the match is), etc.

In addition, upon installing the new feature(s) and/or new software product(s), the user profile manager 212 performs the step 310a of updating users and corresponding software products. For example, the user profile manager 212 updates a database that associates a user profile corresponding to the user of the client device 102 with the new feature(s) and/or new software product(s) installed on the client device 102.

In one or more embodiments, based upon determining that the geolocation information associated with the client device relates to an electronic survey, the survey system 102 may determine if the electronic survey requires multiple visits to the geographic area in order to be provided to the client device 104. Specifically, the survey system 102 queries the survey database to determine a required number of visits of the electronic survey indicated in the first table 234 of the survey database. If the survey system 102 determines that the electronic survey requires two of more visits by a client device 104 prior to the survey system providing the electronic survey to the client device 104, the survey system 102 returns to step 209 of FIG. 2A (i.e., analyzing the geolocation information associated with the client device 104) to determine how many times the client device 104 has visited the geographic area associated with the electronic survey.

Upon returning to step 209 of FIG. 2A and analyzing the geolocation information associated with the client device 104, the survey system 103 queries the survey database to determine if additional geolocation information (e.g., prior geolocation information) associated with the client device 104 is stored in the survey database. If the survey system 102 determines that prior geolocation information associated with the client device 104 is stored in the survey database, the survey system 102 analyzes the prior geolocation information in conjunction with the current geolocation information to determine how many times the client device 104 has visited the geographic area. After determining how many times the client device 104 has visited the geographic area, the survey system 102 compares the number of times the client device 104 has visited the geographic area to the required number of visits and determines if the client device 104 has visited the geographic area a sufficient amount of times.

If the survey system 102 determines that the client device 104 has visited the geographic area a sufficient number of times, the survey system 102 may proceed to step 211 of FIG. 2A, which is discussed in further detail below. If, on the other hand, the survey system 102 determines that the client device 104 has not visited the geographic area a sufficient number of times, the survey system 102 determines to not provide the electronic survey to the client device 104 until the client device 104 has visited the geographic area a sufficient times (e.g., until the survey system 102 receives further geolocation information associated with the client device 104 indicating that the client device 104 has visited the geographic area a sufficient times).

In some alternative embodiments, based upon determining that the client device 104 has visited the geographic area a sufficient number of times, the survey system 102 determines whether the visits happened within a required period of time. Specifically, the survey system 102 queries the survey database to determine whether the electronic survey requires that the required number of visits occur within a specific period of time. If the survey system 102 determines that the electronic survey requires that the visits occur within a specific period of time, the survey system 102 analyzes the geolocation information (e.g., the locations indicated in the geolocation information and the associated timestamps) to determine whether the visits occurred in the appropriate period of time. If the visits occurred in the appropriate period of time, the survey system 102 may proceed to step 211, which is discussed in further detail below. If, on the other hand, the survey system 102 determines that the visits did not occur within the appropriate period of time, the survey system 102 determines to not provide the electronic survey to the client device 104.

Based upon determining that the geolocation information relates to an electronic survey and/or that the other parameters associated with the electronic survey are satisfied, the survey system can provide a survey question from the electronic survey to the client device 104. For instance, in some embodiments the survey system 102 provides the an electronic survey question to the client device 104 in response to determining the geolocation information associated with the client device 104 relates to a geographic area associated with an electronic survey. In one or more alternative embodiments, the survey system 102 determines a timing of providing the electronic survey to the client device 104 (e.g., based on one or more settings or preferences associated with an electronic survey.

Specifically, as show in step 211 of FIG. 2A, the survey system 102 accesses the survey database to determine the timing 240 associated with the electronic survey as indicated in the first data table 234 of the survey database, as shown in FIG. 3. As discussed briefly above, the timings may indicate providing the electronic survey to a client device 104 as soon as possible after the client device 104 enters the geographic area associated with the electronic survey, upon determining that the client device 104 is within the geographic area, after the client device 104 has been located within a geographic area for a specified amount of time, after the client device 104 leaves the geographic area, or after the client device 104 passes through a particular portion of the geographic area. Depending on network.

However, as noted above, in some embodiments, the first table 234 may indicate that the timing of distributing the electronic survey is variable and may be determined based on the geolocation information associated with the client device 104. In other words, based on the geolocation information from the client device 104, the survey system 102 may determine a time (e.g., a best time) to provide the electronic survey (e.g., a time when a potential respondent 110 is most likely to respond) to the client device 104. In such embodiments, the survey system 102 may return to step 209 to analyze to geolocation information to determine a time to provide the electronic survey. Furthermore, the survey system 102 may query the survey database for prior geolocation information associated with the client device 104 to include in the analysis to determine a time to provide the electronic survey.

The survey system 102 may determine a timing to provide the survey by determining locations indicated in the geolocation information and comparing them to real world locations. In some embodiments, the survey system 102 may compare the locations indicated in the geolocation information with real world locations by communicating with third-party applications as discussed above. Furthermore, based on the real-world locations indicated (through comparison) in the geolocation information, the survey system 102 may determine a timing to provide the electronic survey to the client device 104. For example, the geolocation information may indicate that the client device 104 is generally located at a first geographic area (e.g., a residential location) in the evening and generally located at a second geographic area (e.g., a business location) during the morning and afternoon. The survey system 102 may determine, based on the client device 104 being located in a residential location during the evening, that a respondent may be more likely to respond during the evening. Thus, the survey system 102 determines a timing of providing the electronic survey to be during an evening. According, one or more embodiments of the survey system 102 optimizes a timing to provide electronic surveys to a particular client device 104.

As illustrated in FIG. 2A, in addition to the survey system 102 determining the timing of providing the electronic survey, in one or more embodiments the survey system 102 determines whether the electronic survey related to the geolocation information is assigned as a preconfigured electronic survey or a variable survey, as shown in step 212. Specifically, the survey system queries the survey database to determine whether the electronic survey is indicated as preconfigured in the first table 234 of the survey database, as discussed above in detail with reference to FIG. 3.

Based on a determination that the electronic survey is a preconfigured electronic survey, the survey system 102 may provide the electronic survey to client device 104 as shown in step 220 of FIG. 2A, and as will be discussed in further detail below. On the other hand, based on the determination that the electronic survey is a variable electronic survey, the survey system 102 may prepare at least one survey question to distribute as the electronic survey, as shown in step 214 of FIG. 2A.

In one or more embodiments, based on the electronic survey being an variable electronic survey, the survey system 102 prepares at least one survey question to distribute as the electronic survey by selecting an already created survey question, as shown in step 216 of FIG. 2A. For example, the survey system 102 selects a survey question stored in the survey database of the survey system 102. Specifically, the survey system 102 may query the survey database of the survey system 102 to compare the sub-geographic areas of the defined geographic area with the determined geolocation information of the client device 104. Furthermore, the survey system 102 may query the survey database of the survey system 102 to compare triggers of the survey database with the determined geolocation information of the client device 104.

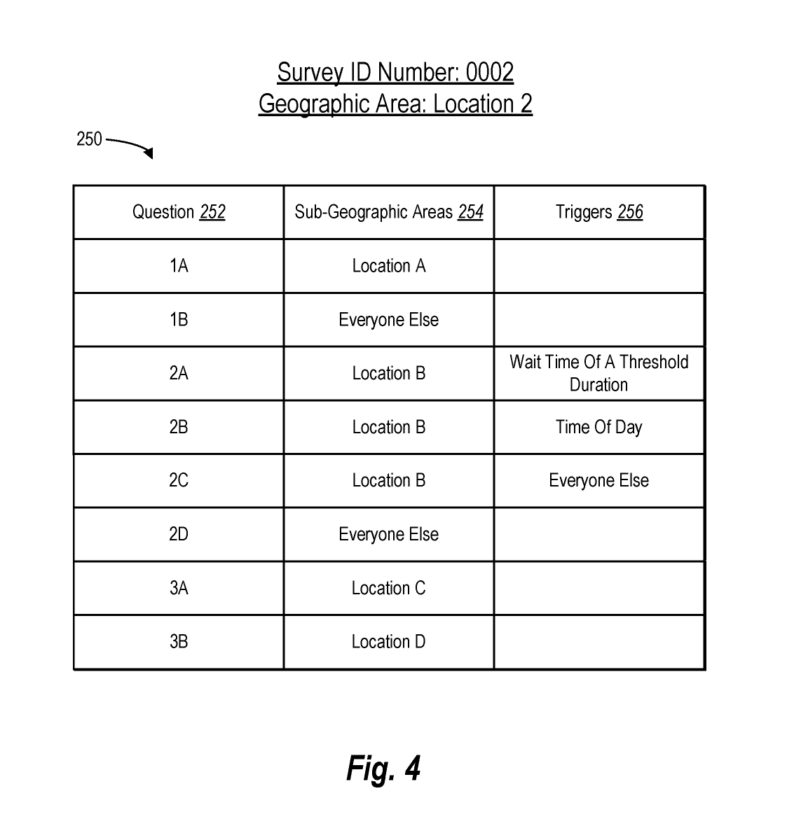

FIG. 4 illustrates an example second data table 250 within the survey database. The electronic survey system 102 can use the second data table 250 to compare the geolocation information of the client device 104 with sub-geographic areas and triggers stored in the survey database in order to select survey questions to include in the electronic survey.

The second data table 250 may include a survey question ID number column 252. For example, the survey question ID number column 252 may include a plurality of survey question ID numbers (e.g., questions: 1A, 1B, 2A, 2B, 2C, etc.) that are available within specific electronic survey (e.g., electronic survey 0002). The survey question ID numbers may be organized in one or more question groups. Each question group may represent a potential question to include in an electronic survey. For example, a first question group may include questions 1A and 1B, and a second question group may include questions 2A, 2B, and 2C. Furthermore, in some embodiments, as will be discussed below, when selecting survey questions for an electronic survey, a single question must be selected from each question group to include in the electronic survey.

In addition, the second data table 250 may include a sub-geographic areas column 254, as illustrated in FIG. 4. Each sub-geographic area in the sub-geographic areas column 254 represents a portion of a geographic area (e.g., Location 2) associated with the electronic survey. The sub-geographic locations in the sub-geographic areas column 254 the survey database may include the various types of defined sub-geographic locations as discussed throughout this disclosure. Furthermore, sub-geographic areas column 254 of the survey database may include one or more global (e.g., “everyone else”) column locations (referred to hereinafter as “global cells”). As will be discussed in further detail below, the global cells facilitate assigning survey questions to the electronic survey when the geolocation information does not indicate one or more of the listed sub-geographic areas.

Each survey question ID number is associated with a sub-geographic area or global cell within the sub-geographic areas column 254 of the survey database (e.g., associated in the second data table 250 via a row). However, the survey question ID numbers may be associated with the sub-geographic areas or global cells of the sub-geographic areas column 254 in any manner known in the art for associating data.

Additionally, the second data table 250 may include a trigger column 256, as illustrated in FIG. 3. Each triggers of the trigger column 256 represents a trigger (e.g., specified wait time, time of day, etc.) that may be indicated in the geolocation information. For example, the triggers of the trigger column 256 represent the triggers discussed above in regard to step 202 of FIG. 2A. The survey database may also include one or more global cells (e.g. “everyone else” cells) in the trigger column 256. Each survey question ID number may be associated with a trigger or a global cell within the second data table 250 of the survey database.

Referring back to FIG. 2A and step 216, as mentioned above, in selecting a survey question to include in the electronic survey, the survey system 102 queries the survey database, which includes the second data table 250 as discussed above in regard to FIG. 4. The survey system 102 compares the sub-geographic areas of the defined geographic area of the survey database with the determined geolocation information of the client device 104. Second, the survey system 102 compares triggers of the survey database with the determined geolocation information of the client device 104. As a result, the survey system 102 identifies a survey question from a plurality of survey questions to include in the electronic survey.

As mentioned above, the survey system 102 compares the sub-geographic areas listed in the second data table 250 with locations indicated in the geolocation information. If a location indicated in the geolocation information falls within a sub-geographic area (e.g., within a geo-fence defining the sub-geographic area), the survey system 102 determines that the location matches the sub-geographic area of the second data table 250 of the survey database. As discussed above, the sub-geographic areas of the second data table 250 are defined in ranges such that the locations of the geolocation information do not have to be exactly the same in order to fall within the sub-geographic areas.

If the survey system 102 determines that a location indicated in the geolocation information matches a sub-geographic area of at least one survey question, the survey system 102 determines whether additional criteria (e.g., triggers) is needed to select the survey question. For example, as shown in FIG. 4, in some embodiments, a single sub-geographic area may correlate to an entire question group (e.g., 2A, 2B, and 2C). Thus, further criteria are needed to select a survey question from the question group. In such embodiments, the survey system 102 may compare the geolocation information to triggers listed in the second data table 250 and related to the particular question group. If the geolocation information matches a trigger of the question group, the survey system 102 selects the survey question related to the trigger to include in the electronic survey.

In some embodiments, two or more triggers may match the geolocation information associated with the client device 104. In such embodiments, the survey system 102 may merely select the top trigger of the two or more matching triggers within the second data table 250 (e.g., the trigger in highest row of the second data table 250). In other words, the triggers may be prioritized, with the highest priority trigger being related to the first question of a question group (e.g., 2A of FIG. 4).

In some instances, the survey system 102 may determine that locations indicated in the geolocation information from the client device 104 do not match any sub-geographic areas within a question group. In such embodiments, the survey system 102 selects the survey question of the question group related to a global cell 255 (e.g., “everyone else” cell) within the second column to include in the electronic survey. Similarly, in some instances, the survey system 102 may determine that a location indicated in the geolocation information matches a question group but that none of the triggers related to the question group are indicated in the geolocation information. In such a situation, the survey system 102 may select the survey question of the question group related to the global cell 257 to include in the electronic survey. In view of the foregoing, by querying the survey database and comparing the geolocation information from the client device 104 with data maintained in the survey database (e.g., the first data table 234 and second data table 250), the survey system 102 selects one or more questions to include in the electronic survey based on the geolocation information associated with a client device 104.

Returning again to FIG. 2A, after preparing at least one survey question to distribute, the survey system 102 may sends (e.g., distributes) the at least one survey question to the client device 104, as shown in step 220. In one or more embodiments, sending the at least one survey question comprises sending a plurality of questions, and in some cases all the questions of an electronic survey. In other embodiments, the survey system 102 sends a first question, waits for a response to the first question, and then provides a second question based on the response to the first question.

Based upon receiving the at least one survey question, the client device 104 presents the survey question to the respondent 110, as shown in step 222 of FIG. 2A. For example, the client device 104 may present the at least one survey question to the respondent 110 via a display (e.g., touch screen display, monitor, television, or any other display device). Furthermore, the client device 104 may display the electronic survey through an electronic survey GUI, which allows the respondent 110 to interact with the electronic survey. The client device 104 also displays the electronic survey per the electronic survey settings and/or preferences discussed above in regard to step 202 of FIG. 2A.

After displaying the at least one survey question via a display of the client device 104, the client device 104 detects a response via one or more respondent inputs of the client device 104, as shown in step 224 of FIG. 2B. Specifically, the client device 104 may detect at least a portion of a response by detecting one or more interactions with the client device 104 via a user input device (e.g., touch screen, mouse, keyboards, microphone, camera, etc.). For example, a respondent can provide a response to the survey question by selecting an answer with the survey question using a touch gesture (e.g., tap gesture, swipe gesture, pinch gesture, etc.) on a touch screen of a mobile device.

Upon detecting a response, the client device 104 generates data representing the response. More specifically, the client device 104 can create a data packet that references the at least one survey question (e.g., a survey question ID Number) and includes an indication of a response detected in relation to the at least one survey question. Moreover, the client device 104 provides the data packet indicating the response to the electronic survey to the survey system 102, as show in step 226 of FIG. 2B.

After receiving the data packet indicating the response, the survey system 102 may compile the data packet indicating the response with other data packets indicating responses from other client devices 104, and the survey system 102 may analyze the data packets to determine trends indicated within the data packets. Furthermore, the survey system 102 may generate electronic survey reports illustrating the trends, as shown in step 230 of FIG. 2B. The survey system 102 may generate the electronic survey reports using charts, graphs, and/or other graphics. For example, for a multiple-choice question, the survey system 102 may provide a bar graph comparing each answer together. Further, the survey system 102 may update the electronic survey reports as additional answers are received from respondents 110. In one or more embodiments, generating the electronic survey reports can include the survey system 102 providing the reports illustrating the trends to the survey administer device 106, as shown in step 232. In some example embodiments, the survey system 102 may provide the electronic survey reports to the survey administrator device 106 via a website, email, or other electronic communication channel.

FIG. 5 illustrates a schematic diagram of server device 101 having a survey system 102 in accordance with one or more embodiments. The survey system 102 may be an example embodiment of the survey system 102 described in connection with the survey system 102 of FIGS. 1-4. The survey system 102 can include various components for performing the processes and features described herein. For example, and as illustrated in FIG. 5, the survey system 102 includes a survey question identifier 302, a response manager 304, a geolocation analyzer 306, a survey distributor 308, and a survey database 310. In addition, the survey system 102 may include additional components not illustrated, such as those as described below. The various components of the survey system 102 may be in communication with each other using any suitable communication protocols, such as described with respect to FIG. 9 below.

Each component of the survey system 102 may be implemented using one or more computing devices (e.g., server devices 101) including at least one processor executing instructions that cause the survey system 102 to perform the processes described herein. The components of the survey system 102 can be implemented by a single server device 101 or across multiple server devices 101, as described above. Although a particular number of components are shown in FIG. 5, the survey system 102 can include more components or can combine the components into fewer components (such as a single component), as may be desirable for a particular implementation.

As briefly mentioned above, the survey system 102 includes a survey question identifier 302. The survey question identifier 302 may manage the creation of an electronic survey and the composition of one or more survey questions. In particular, the survey question identifier 302 may generate and/or create electronic surveys, which enable the survey administrator device 106 to obtain feedback from respondents 110. For example, the survey question identifier 302 may select survey questions to create and/or organize electronic surveys, as described above in regard to step 202 of FIG. 2A.

As discussed above, the survey system 102 includes a response manager 304. The response manager 304 may manage the collection of responses provided by respondents 110 in response to one or more survey questions provided by the survey system 102. The response manager 304 may collect responses to survey questions provided by respondents 110. The response manager 304 may collect responses in a variety of ways. To illustrate, the response manager 304 may extract responses to a survey question in bulk. For example, the response manager 304 may collect a list of multiple responses to a survey question. In addition, or in the alternative, the response manager 304 may collect responses to a survey question as respondents 110 provided their responses to the survey question.

Once the response manager 304 collects a response to a survey question, the response manager 304 can verify the answer to the survey question provided in the response. In particular, if the respondent 110 is responding to a survey question that includes available answer choices, the response manager 304 can determine that the response includes an answer that corresponds to one of the available answer choices for the survey question. In this manner, the response manager 304 may ensure that only valid answers are being included in the results 316 and/or reports and are stored in the survey system 102, as described below. If the response manager 304 determines that an answer is invalid, the response manager 304 may enable the respondent 110 to re-answer the survey question. In some cases, if the respondent 110 is unavailable, the response manager 304 may disregard the invalid answer in the response.

In some example embodiments, upon collecting and verifying responses, the response manager 304 may store the responses. More specifically, the response manager 304 can store the responses for an electronic survey in the survey database 310. In some instances, the response manager 304 may separately store responses for each survey question. To illustrate, if an electronic survey includes two survey questions, then the response manager 304 can store responses for the first survey question together and responses for the second survey question together. Additionally or alternatively, the response manager 304 may store the responses outside of the survey system 102 or on a system belonging to a third-party.

Further, after verifying that an answer for a survey question is valid, the response manager 304 may compile answers for survey questions into a set of results 316. In some cases, compiling the results 316 may include adding a newly obtained answer to a set of previously compiled results 316. For example, each time a respondent 110 answers a particular survey question for an electronic survey, the response manager 304 may add the newly received answer to answers previously received from other respondents 110 for the same survey question. Additionally, the response manager 304 may compile a set of survey results 316 based on the results 316 for each survey question.

As mentioned above, the survey system 102 includes a geolocation analyzer 306. The geolocation analyzer 306 may analyze geolocation information received by the survey system 102. For example, the geolocation analyzer 306 may analyze the geolocation information to determine: whether the client device 104 has been or is currently located within a geographic area, one or more client devices 104 that are currently located within or have been located within the geographic area, a period of time that the client device 104 was within the geographic area and/or within a portion of the geographic area, a path traveled by a client device 104, when a client device 104 entered the geographic area and when the client device 104 left the geographic area, and/or outliers indicated by the geolocation information, as discussed above in regard to FIG. 2A. Furthermore, the geolocation analyzer 306 may provide results of the analysis performed on geolocation information to the survey question identifier 302 to assist in determining survey questions to include within an electronic survey.

As briefly mentioned above, the survey system 102 includes a survey distributor 308. When the survey system 102 administers an electronic survey, the survey distributor 308 may send and receive the electronic survey to and from designated client devices 104. More specifically, the survey distributor 308 may send and receive electronic surveys to client devices 104 via one or more of the above-describe distribution channels.

In particular, when a survey administrator device 106 selects a particular distribution channel on which to administer an electronic survey, the survey distributor 308 may identify the protocols and communication requirements for the particular distribution channel. For example, when the user selects the option to administer an electronic survey via a website, the survey distributor 308 may identify relevant protocols, such as TCP/IP, HTTP, etc., along with the requirements for each protocol. As another example, when the user selects the option to administer an electronic survey to mobile devices via text message, the survey distributor 308 may identify the protocols for sending and receiving messages via SMS, short message peer-to-peer (SMPP), multimedia messaging service (MMS), enhanced messaging service (EMS), and/or simple mail transport protocol (SMTP).

Furthermore, the survey distributor 308 may determine a timing to distribute an electronic survey to a respondent 110 based on the settings and/or preferences determined by the survey administrator via the survey administrator device 106 and as discussed above in regard to step 202 of FIG. 2A. For example, the survey distributor 308 may determine a timing based on the following: when a client device 104 enters and/or leaves a geographic area, the client device 104 being currently located within the geographic area, a number of client devices 104 currently located within a geographic area, and/or a client device's 104 movement within the geographic area, as described above in regard to FIG. 2A.

In some example embodiments, the survey distributor 308 may use one or more third-party services to distribute an electronic survey to client devices 104. For instance, the survey distributor 308 may use a third-party service that is specialized in distributing information via a particular distribution channel. For example, if the electronic survey is to be administered via text message, the survey system 102 may employ a third-party text messaging service to send and receive the electronic survey.

The survey distributor 308 may provide navigational tools and options to the respondent 110 based on the distribution channel that the survey distributor 308 uses to send an electronic survey to a respondent 110. For example, when administering an electronic survey via a website, the survey distributor 308 may provide navigational tools, such as a progress indicator, and navigational options, such forward and back, to the respondent 110. As another example, when administering an electronic survey via text message, the survey distributor 308 may provide navigational tools and options that allow a respondent 110 to skip a question, return to a previous question, stop the electronic survey, get progress update, etc. Due to the nature of text messages, however, the survey distributor 308 may provide these tools and options to a respondent 110 upon a respondent 110 sending particular key words in a response, such as “skip,” “back,” “stop,” “status,” etc.

In one or more embodiments, the survey distributor 308 may provide an option for a respondent 110 to pause an electronic survey and resume the electronic survey using a different distribution channel. For example, when a respondent 110 is completing an electronic survey via a text message on a mobile device, the respondent 110 may respond with “web access,” “online version,” or some other type of response indicating a desire to continue the electronic survey online. In response, the survey distributor 308 may provide the respondent 110 with a link (e.g., URL), which when selected, allows the respondent 110 to continue the electronic survey online rather than by text message. In some embodiments, the user designs the electronic survey to automatically include the link in the electronic survey (e.g., at the beginning of the electronic survey), such that the respondent 110 can use the link at anytime to continue the electronic survey via a different distribution channel. Likewise, a respondent 110 completing the electronic survey online may select an option, such as a link built into or presented by the electronic survey, to continue the electronic survey via an alternative distribution channel, such as email, text message, instant message, app badge, icon, etc.

Further, when available, the survey distributor 308 may provide an option for a respondent 110 to select a language preference. The preference may be applied on a per electronic survey basis or applied to future electronic surveys for the respondent 110 (e.g., such as a global preference). Depending on the distribution channel on which the electronic survey is administered, the option to set a language preference may be displayed as an option within the electronic survey.

As mentioned above, the survey system 102 includes a survey database 310. The survey database 310 may include a single database or multiple databases. In addition, the survey database 310 may be located within the survey system 102. Alternatively, the survey database 310 may be external to the survey system 102, such as in cloud storage. Further, the survey database 310 may store and provide data and information to the survey system 102, as further described below and as described above in regard to FIGS. 2A and 2B.

The survey database 310 may include electronic surveys 312, such as electronic surveys 312 created via the survey question identifier 302. Further, the survey database 310 may also include electronic surveys 312 created via the survey administrator device. Moreover, the survey database 310 may include results 316 from the completed electronic surveys and a user database 318 storing profiles of respondents 110. In addition, the survey database 310 may store information about each electronic survey 312, such as parameters and preferences that correspond to each electronic survey 312.

Each electronic survey 312 may have a survey identifier number (or simply “survey ID number”) to provide unique identification. In some cases, the electronic surveys 312 may be organized according to survey ID number. Alternatively, electronic surveys 312 in the survey database 310 may be organized according to other criteria, such as creation date, last modified date, closing time, most recent results, etc. Further, the survey database 310 may associate access codes with a survey ID number, such that the survey system 102 can identify to which electronic survey a response corresponds when the response includes an access code.

As shown in FIG. 5, the electronic surveys 312 of the survey database 310 may include survey questions 314 and results 316. More specifically, each electronic survey 312 may include a set of potential survey questions 314. The survey system 102 may store the survey questions 314 grouped by electronic survey. Further, each survey question 314 may have a unique question identifier number (or simply “question ID number”). In some cases, the question ID number may also identify the electronic survey 312 to which the survey question 314 belongs. For example, all survey questions 314 from a particular electronic survey 312 may include the survey ID number within the question ID number.

Further, each survey question 314 may be associated with a set of results 316, or a compilation of answers associated with the survey question 314. Accordingly, along with survey questions 314, the electronic surveys 312 may include results 316. When a respondent 110 provides an answer to a survey question 314, the survey system 102 may add the answer as part of the results 316. As such, the results 316 may include a cumulative set of answers for a survey question 314. Further, each result 316 may have a unique results identifier (or simply “result ID”). In some instances, the result ID may identify the electronic survey 312 and/or the question to which the result 316 corresponds. For instance, based on the result ID, the survey system 102 is able to identify the corresponding survey question 314 and/or the electronic survey 312.

As mentioned briefly above, the survey database 310 may also include a user database 318 for storing profiles of respondents 110. The user database 318 may include known information about respondents 110 including, for example, age, gender, home address, telephone number, etc. Furthermore, the user database 318 may include a record of electronic surveys 312 completed by a respondent 110. Moreover, the user database 318 may include an indication of a geographic area where the respondent 110 completed each electronic survey 312 and an indication of geographic areas where the respondent 110 was located but did not complete electronic surveys 312. Furthermore, as mentioned above, the survey system 102 may utilize such information to optimize a timing to provide electronic surveys 312 to the respondent 110, as discussed above in regard to FIG. 2.

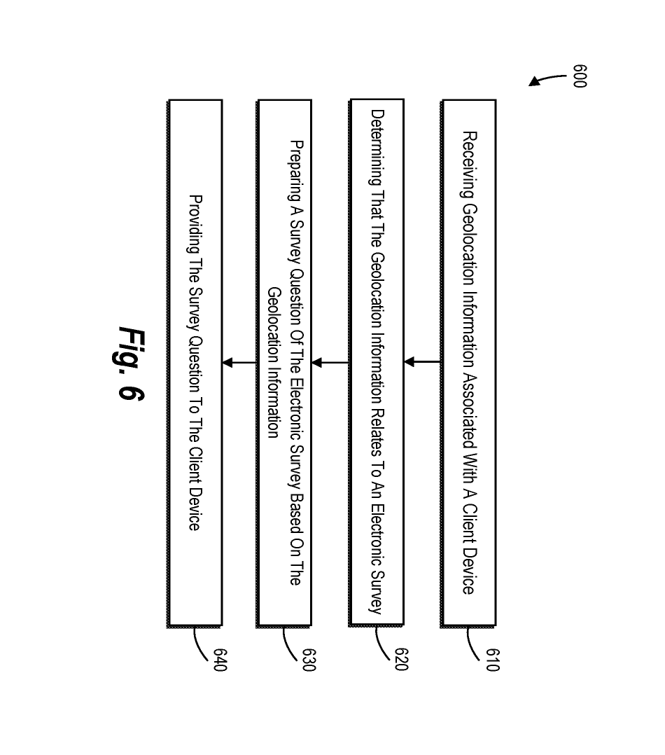

FIG. 6 illustrates a flowchart of an example method 600 for distributing an electronic survey based on geolocation information associated with a client device 104. The method 600 can be implemented by the survey system 102 described above. The method 600 involves an act 610 of receiving geolocation information associated with a client device 104. Receiving geolocation information associated with the client device 104 may include receiving a first location associated with the client device 104 and receiving a second different location associated with the client device 104. Furthermore, receiving geolocation information associated with the client device 104 may include receiving geolocation information indicating a plurality of locations over a period of time. Moreover, receiving geolocation information associated with the client device 104 may include any of the actions discussed above in regard to FIG. 2A.

Additionally, the method 600 involves an act 620 of determining, by at least one processor, that the geolocation information relates to an electronic survey. Act 620 may include comparing locations indicated in the geolocation information associated with the client device 104 with geographic areas associated with the electronic survey. Furthermore, in some embodiments, the method 600 may include comparing a plurality of locations of a path traveled by the client device as indicated in the geolocation information with a plurality of locations of a defined path associated with the electronic survey. Moreover, the method 600 may include any of the actions discussed above in regard to step 210 of FIG. 2A.

Furthermore, the method 600 involves an act 630 of preparing at least one survey question of the electronic survey based on the geolocation information. In particular, the act 630 may include selecting the at least one survey question from a list of survey questions correlating to the geolocation information. In additional embodiments, the act 630 may at least partially include determining at least one survey question based on a first location and providing the at least one survey question to the client device based on the second different location. Additionally, the act 630 may include any of the actions described above in regard to steps 214 and 216 of FIG. 2A.

The method 600 also involves an act 640 of providing the at least one survey question to the client device 104. For example, the act 640 may include providing the at least one survey question to a respondent application 105 of the client device 104. As another non-limiting example, the act 640 may include providing the at least one survey question to the client device 104 via an electronic message. Additionally, the act 640 may include any of the actions described above in regard to step 220 of FIG. 2A.

In addition to the steps illustrated, method 600 can also include determining a timing to provide the at least one survey question of the electronic survey based on the geolocation information. Additionally, method 600 can also include determining whether the client device visited a geographic area two or more times and whether the client device visited the geographic area two or more times within a defined period of time. Furthermore, method 600 can include requesting the geolocation information from the client device prior to receiving the geolocation information associated with the client device and/or determining whether the electronic survey relating to the geolocation information is a preconfigured electronic survey or a variable survey. In further embodiments, method 600 may include determining that the electronic survey relating to the geolocation information is a variable survey, and selecting a first plurality of survey questions to include in the electronic survey from a second larger plurality of survey questions.

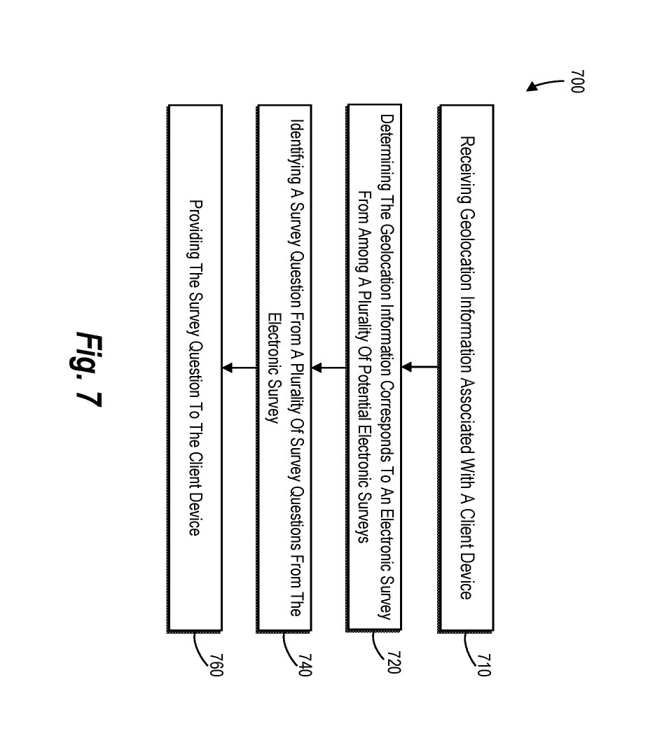

FIG. 7 illustrates a flowchart of another example method 700 for distributing an electronic survey based on geolocation information associated with a client device 104. The method 700 can be implemented by the survey system 102 described above. The method 700 involves an act 710 of receiving geolocation information associated with a client device 104. Receiving geolocation information associated with the client device 104 may include receiving a first location associated with the client device 104 and receiving a second different location associated with the client device 104. Furthermore, receiving geolocation information associated with the client device 104 may include receiving geolocation information indicating a plurality of locations over a period of time. Moreover, receiving geolocation information associated with the client device 104 may include any of the actions discussed above in regard to FIG. 2A.

The method 700 may further include an act 720 of determining, by at least one processor, the geolocation information corresponds to an electronic survey from among a plurality of potential electronic surveys, wherein the electronic survey comprises a plurality of survey questions. Act 720 may include comparing locations indicated in the geolocation information associated with the client device 104 with geographic areas associated with the electronic survey. Furthermore, in some embodiments, the method 700 may include comparing a plurality of locations of a path traveled by the client device as indicated in the geolocation information with a plurality of locations of a defined path associated with the electronic survey. Moreover, the method 700 may include any of the actions discussed above in regard to step 210 of FIG. 2A.

Additionally, the method 700 includes an act 740 of identifying, by the at least one processor and based on the geolocation information, a survey question from the plurality of survey questions. Act 740 may include comparing locations indicated in the geolocation information to sub-geographic areas of a geographic area associated with the plurality of survey questions and determining that one or more locations indicated in the geolocation information match one or more sub-geographic areas if the one or more locations fall within the sub-geographic areas. Act 740 may further include comparing triggers (as discussed above in regard to FIG. 3) indicated in the geolocation information with triggers associated with plurality of survey questions. Furthermore, act 740 may include any of the actions described above in regard to steps 214 and 216 of FIG. 2A.

The method 700 also involves an act 760 of providing the survey question to the client device 104. For example, the act 640 may include providing the at least one survey question to a respondent application 105 of the client device 104. As another non-limiting example, the act 760 may include providing the at least one survey question to the client device 104 via an electronic message. Additionally, the act 760 may include any of the actions described above in regard to step 220 of FIG. 2A.

In addition to the steps illustrated, method 700 can also include determining a timing to provide the survey question of the electronic survey based on the geolocation information. Determining the timing to provide the survey question can include determining to provide the survey question to the client device a period of time after the client device enters a geographic area as indicated in the geolocation information. In alternative embodiments, determining the timing to provide the survey question can include determining to provide the survey question to the client device a period of time after the client device leaves a geographic area as indicated in the geolocation information. Additionally, method 700 can also include determining whether the client device visited a geographic area two or more times and whether the client device visited the geographic area two or more times within a defined period of time. Furthermore, method 700 can include receiving the plurality of potential electronic surveys from a survey administer device prior to receiving the geolocation information associated with the client device. Moreover, method 700 can include requesting geolocation information associated with at least one client device and identifying the at least one client device of the plurality of client devices to which to provide the at least one survey question based on the geolocation information associated with the at least one client device.

FIG. 8 illustrates a block diagram of an example computing device 800 that may be configured to perform one or more of the processes described above. One will appreciate that one or more computing devices such as the computing device 800 may implement the survey system 102, client device 104, and/or survey administrator device 106 described above. As shown by FIG. 8, the computing device 800 can comprise a processor 802, a memory 804, a storage device 806, an I/O interface 808, and a communication interface 810, which may be communicatively coupled by way of a communication infrastructure 812. While an example computing device 800 is shown in FIG. 8, the components illustrated in FIG. 8 are not intended to be limiting. Additional or alternative components may be used in other embodiments. Furthermore, in certain embodiments, the computing device 800 can include fewer components than those shown in FIG. 8. Components of the computing device 800 shown in FIG. 8 will now be described in additional detail.

In one or more embodiments, the processor 802 includes hardware for executing instructions, such as those making up a computer program. As an example, and not by way of limitation, to execute instructions, the processor 802 may retrieve (or fetch) the instructions from an internal register, an internal cache, the memory 804, or the storage device 806 and decode and execute them. In one or more embodiments, the processor 802 may include one or more internal caches for data, instructions, or addresses. As an example and not by way of limitation, the processor 802 may include one or more instruction caches, one or more data caches, and one or more translation look aside buffers (TLBs). Instructions in the instruction caches may be copies of instructions in the memory 804 or the storage 806.

The memory 804 may be used for storing data, metadata, and programs for execution by the processor(s). The memory 804 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 804 may be internal or distributed memory.

The storage device 806 includes storage for storing data or instructions. As an example and not by way of limitation, storage device 806 can comprise a non-transitory storage medium described above. The storage device 806 may include a hard disk drive (HDD), a floppy disk drive, flash memory, an optical disc, a magneto-optical disc, magnetic tape, or a Universal Serial Bus (USB) drive or a combination of two or more of these. The storage device 806 may include removable or non-removable (or fixed) media, where appropriate. The storage device 806 may be internal or external to the computing device 800. In one or more embodiments, the storage device 806 is non-volatile, solid-state memory. In other embodiments, the storage device 806 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 808 allows a user to provide input to, receive output from, and otherwise transfer data to and receive data from computing device 800. The I/O interface 808 may include a mouse, a keypad or a keyboard, a touch screen, a camera, an optical scanner, network 108 interface, modem, other known I/O devices or a combination of such I/O interfaces. The I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 808 is configured to provide graphical data to a display for presentation to a user. The graphical data may be representative of one or more graphical user interfaces and/or any other graphical content as may serve a particular implementation.

The communication interface 810 can include hardware, software, or both. In any event, the communication interface 810 can provide one or more interfaces for communication (such as, for example, packet-based communication) between the computing device 800 and one or more other computing devices or networks. As an example and not by way of limitation, the communication interface 810 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 810 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 810 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 810 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 812 may include hardware, software, or both that couples components of the computing device 800 to each other. As an example and not by way of limitation, the communication infrastructure 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 9 illustrates an example network environment 900 of a survey system 102. Network environment 900 includes a client system 906, and a survey system 902 connected to each other by a network 904. Although FIG. 9 illustrates a particular arrangement of client system 906, survey system 902, and network 904, this disclosure contemplates any suitable arrangement of client system 906, survey system 902, and network 904. As an example and not by way of limitation, two or more of client system 906, and survey system 902 may be connected to each other directly, bypassing network 904. As another example, two or more of client system 906 and survey system 902 may be physically or logically co-located with each other in whole, or in part. Moreover, although FIG. 6 illustrates a particular number of client systems 906, survey systems 902, and networks 904, this disclosure contemplates any suitable number of client systems 906, survey systems 902, and networks 904. As an example and not by way of limitation, network environment 900 may include multiple client system 906, survey systems 902, and networks 904.

This disclosure contemplates any suitable network 904. As an example and not by way of limitation, one or more portions of network 904 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 904 may include one or more networks 904.

Links may connect client system 906, and survey system 902 to communication network 904 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links may differ in one or more respects from one or more second links.

In particular embodiments, client system 906 may be an electronic device including hardware, software, or embedded logic components or a combination of two or more such components and capable of carrying out the appropriate functionalities implemented or supported by client system 906. As an example and not by way of limitation, a client system 906 may include any of the computing devices discussed above in relation to FIG. 5. A client system 906 may enable a network user at client system 906 to access network 904. A client system 906 may enable its user to communicate with other users at other client systems 906.

In particular embodiments, client system 906 may include a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at client system 906 may enter a Uniform Resource Locator (URL) or other address directing the web browser to a particular server (such as server, or a server associated with a third-party system), and the web browser may generate a Hyper Text Transfer Protocol (HTTP) request and communicate the HTTP request to server. The server may accept the HTTP request and communicate to client system 906 one or more Hyper Text Markup Language (HTML) files responsive to the HTTP request. Client system 906 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, survey system 902 may include a variety of servers, sub-systems, programs, modules, logs, and data stores. In particular embodiments, survey system 902 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Survey system 902 may also include suitable components such as network interfaces, security mechanisms, load balancers, failover servers, management-and-network-operations consoles, other suitable components, or any suitable combination thereof.

In particular embodiments, survey system 902 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. Additionally, a user profile may include financial and billing information of users (e.g., respondents 110, customers, etc.).

The foregoing specification is described with reference to specific example embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this invention. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and legal equivalents.

We claim:

1. A method comprising:
receiving geolocation information associated with a client device;
determining, by at least one processor, that the geolocation information relates to an electronic survey;
preparing at least one survey question of the electronic survey based on the geolocation information; and
providing the at least one survey question to the client device.

2. The method of claim 1, further comprising preparing the at least one survey question of the electronic survey by selecting the at least one survey question from a list of survey questions correlating to the geolocation information.

3. The method of claim 1, further comprising determining a timing to provide the at least one survey question of the electronic survey based on the geolocation information.

4. The method of claim 1, wherein receiving geolocation information associated with a client device comprises:
receiving a first geolocation associated with the client device; and
receiving a second geolocation associated with the client device, wherein the first geolocation and the second geolocation are different.

5. The method of claim 4, further comprising determining the at least one survey question based on the first geolocation, and providing the at least one survey question to the client device based on the second different geolocation.

6. The method of claim 1, further comprising:
determining the client device visited a geographic area two or more times based on the geolocation information; and
wherein preparing the at least one survey question of the electronic survey is based on determining the client device visited a geographic area two or more times.

7. The method of claim 1, further comprising:
determining the client device visited a geographic area two or more times within a defined period of time based on the geolocation information; and
wherein preparing the at least one survey question of the electronic survey is based on determining the client device visited a geographic area two or more times within a defined period of time.

8. The method of claim 1, further comprising wherein receiving geolocation information associated with the client device comprises receiving geolocation information indicating a plurality of locations over a period of time.

9. The method of claim of claim 8, further comprising:
analyzing the plurality of locations over a period of time and interpolating a path traveled by the client device; and
wherein preparing at least one survey question of the electronic survey is based on the path traveled by the client device.

10. The method of claim of claim 1, further comprising determining the electronic survey relating to the geolocation information is one of a preconfigured electronic survey or a variable survey.

11. The method of claim 1, further comprising:
determining that the electronic survey relating to the geolocation information is a variable survey; and
selecting a subset of survey questions from a plurality of survey questions to include in the electronic survey.

12. A method comprising
receiving geolocation information associated with a client device;
determining, by at least one processor, the geolocation information corresponds to an electronic survey from among a plurality of potential electronic surveys, wherein the electronic survey comprises a plurality of survey questions;
identifying, by the at least one processor and based on the geolocation information, a survey question from the plurality of survey questions; and
providing the survey question to the client device.

13. The method of claim 12, further comprising determining a timing to provide the survey question to the client device based on the geolocation information.

14. The method of claim 13, wherein determining a timing comprises determining to provide the survey question to the client device a period of time after the client device enters a geographic area as indicated by the geolocation information.

15. The method of claim 13, wherein determining a timing comprises determining to provide the survey question to the client device a period of time after the client device leaves a geographic area as indicated in the geolocation information.

16. The method of claim 12, further comprising receiving the plurality of potential electronic surveys from a survey administer device, wherein one or more of the plurality of potential electronic surveys is related to a geographic area.

17. The method of claim 13, further comprising determining the survey question based on the first geolocation, and providing the survey question to the client device based on the second different geolocation.

18. A system comprising:
at least one processor; and
at least one non-transitory computer readable storage medium storing instructions thereon that, when executed by the at least one processor, cause the system to:
receive geolocation information associated with a client device;
determine at least one survey question based on the geolocation information; and
provide the survey question to the client device.

19. The system of claim 18, further comprising instructions that, when executed by the at least one processor, cause the system to:
determine the geolocation information is associated with a particular time period; and
wherein preparing the at least one survey question of the electronic survey is further based on determining the geolocation information is associated with the particular time period.

20. The system of claim 19, further comprising instructions that, when executed by the at least one processor, cause the system to:
determine that the electronic survey relating to the geolocation information is a variable survey; and
select a subset of survey questions from a plurality of survey questions to include in the electronic survey.
